(19) United States
(12) Patent Application Publication
(10) Pub. No.: US 2004/0169793 A1
(43) Pub. Date: Sep. 2, 2004

(54) Liquid crystal display

(76) Inventors: Masumitsu Ino, Kanagawa (JP); Tsutomu Tanaka, Kanagawa (JP); Yoko Fukunaga, Kanagawa (JP); Hidemasa Yamaguchi, Kanagawa (JP); Shinji Nakamura, Kanagawa (JP)

Correspondence Address: Holland & Knight, 30th Floor, 131 South Dearborn, Chicago, IL, 60603, US

(21) Appl. No.: 10/479,673

(22) PCT Filed: Apr. 4, 2003
(86) PCT No.: PCT/JP03/04339

(30) Foreign Application Priority Data
Apr. 4, 2002 (JP) 2002-102504
Jun. 14, 2002 (JP) 2002-174895

(51) Int. Cl. G02F 1/1335

(52) U.S. Cl. 349/106

(57) ABSTRACT

A liquid crystal display improving luminance etc. in a reflection type display without being accompanied by an increase of production steps, and able to secure a luminance etc. in a transmission type display at an equivalent level to that of a display device for only a transmission type display, having a display panel comprising a TFT substrate 1 formed with a pixel region 4 having a reflection region A for reflection type display and a transmission region B for transmission type display and a color filter substrate 2 formed with color filters 29 located corresponding to the pixel region 4 arranged facing each other across a liquid crystal layer 3, the color filters 29 located corresponding to the reflection region A being formed under the same conditions as those for the color filters 29a located corresponding to the transmission region B, specifically by the same thickness and the same material. Further, the color filters 29 located corresponding to the reflection region A are formed with at least one opening 33.

### TECHNICAL FIELD

The present invention relates to a liquid crystal display, more particularly relates to a liquid crystal display using reflection type display and transmission type display together.

### BACKGROUND ART

Liquid crystal displays are being used as displays of a broad spectrum of electronic apparatuses making use of their characteristics of being thin in shape and low in power consumption. For example, there are laptop type personal computers, displays for car navigation, personal digital assistants (PDAs), mobile phones, digital cameras, video cameras, and other electronic apparatuses using liquid crystal displays. Such liquid crystal displays include, roughly classified, transmission type liquid crystal displays controlling the passage and blocking of light from an internal light source referred to as a backlight by a liquid crystal panel to perform the display and reflection type displays for reflecting sunlight or other external light by a reflection plate or the like to control the passage and blocking of this reflected light by the liquid crystal panel and perform the display.

In a transmission type liquid crystal display, the backlight accounts for 50 percent or more of the total power consumption, so it is difficult to reduce the power consumption. Further, a transmission type liquid crystal display also has the problem that the display looks dark where the ambient light is bright, so the viewability is lowered. On the other hand, in a reflection type liquid crystal display, a backlight is not provided, so there is no problem of an increase of the power consumption, but there is also a problem that the viewability is sharply lowered when the ambient light is low.

In order to solve such problems of both of the transmission type and reflection type display devices, a dual reflection and transmission type liquid crystal display realizing both transmission type display and reflection type display by one liquid crystal panel has been proposed. This dual reflection and transmission type liquid crystal display performs the display by the reflection of the ambient light when the surroundings are bright, while performs the display by the light of the backlight when the surroundings are dark.

In the above dual transmission and reflection type liquid crystal display, at the time of transmission type display, the display is carried out by the light from an internal light source passing through the color filters only one time. Contrary to this, at the time of reflection type display, the display is carried out by ambient passing through the color filters when the light strikes it from the outside and when the light is reflected and emitted to the outside, i.e., two times. In this way, the light passes through the color filters one more time in reflection type display than transmission type display, so the amount of attenuation of the light becomes extremely large in comparison with the case of transmission type display and becomes a cause of a drop in reflectance. Further, along with this drop in the reflectance, the problems arise that the display luminance and color reproducibility in the reflection type display are lowered and the viewability deteriorates.

For this reason, in a dual transmission and reflection type liquid crystal display, in order to solve the above problems, the color filters corresponding to the reflection region are formed thin, a pigment dispersed in the resin suitable for a reflection type liquid crystal display is used, or a different material is otherwise used so as to reduce the amount of attenuation of the light at the reflection region and raise the reflectance.

In a method of forming the color filters for the reflection region and the color filters for the transmission region by different thicknesses or materials explained above, it is necessary to separately perform a step of forming the color filters for the transmission region and a step of forming the color filters for the reflection region. Specifically, it is necessary to perform six steps in total, that is, forming the color filters for the reflection region by three steps for red (R), green (G), and blue (B) and then forming the color filters for the transmission region by three steps for R, G, and B. Due to such an increase of the steps, the production efficiency of the liquid crystal display was lowered.

On the other hand, the conventional dual reflection and transmission type liquid crystal display has a liquid crystal panel structure stressing the reflection type. At the time of transmission type display, irrespective of the fact that a luminance similar to that of a transmission type display device is desired, the transmission luminance is sacrificed to secure the reflectance by reducing the transmission region and securing a wider area for the region for reflecting the ambient light.

However, depending on the type of the electronic apparatus used, there are also cases where the transmission type display is used more frequently than the reflection type display. Accordingly, in a dual reflection and transmission type liquid crystal display, it is necessary to improve the luminance etc. in the reflection type display as explained above and, at the same time, it is necessary to secure a sufficient level of the luminance and the color reproducibility in the transmission type display.

Further, while such a dual reflection and transmission type liquid crystal display is considered to provide both of transmission type display and reflection type display, there has been the problem that the luminance is insufficient and the viewability low in comparison with the usual reflection type and the usual transmission type liquid crystal displays.

In a liquid crystal display, it is desirable to improve the viewability of the display both when used indoors and when used outdoors. For this reason, in a dual reflection and transmission type liquid crystal display, an improvement of the viewability is desirable for both of the case when it is used as the reflection type and the case when it is used as the transmission type.

In the pixel region of a liquid crystal display panel, due to the structure, a nondisplay region occurs which is unusable for the display. The area of such a nondisplay used region should be reduced as much as possible and the area of the display region raised to the largest limit. Further, when light from the surroundings strikes the display panel and reflection type display is carried out, it is necessary to keep to the minimum the loss of the incident light due to scattering and absorption at the components of the liquid crystal display panel. Due to this, the luminance of the reflection type display can be improved.

To attain the above object and improve the display viewability of the reflection type display and the transmission type display, it is necessary to optimize the structure of the liquid crystal display. However, a method of resolution complicating the production steps is not preferred.

Further, when the light not for the display strikes the liquid crystal layer due to the reflection of the incident light at places other than the display region, for example, due to the reflection on data signal lines for transmitting the image data to pixels, there is the problem of the inconvenience of the state of the liquid crystal layer becoming unstable and the image quality deteriorating.

### DISCLOSURE OF THE INVENTION

A first object of the present invention is to provide a dual reflection and transmission type liquid crystal display improving the luminance and the color reproducibility in the reflection type display without being accompanied by an increase of the production steps, and securing a luminance and color reproducibility in the transmission type display of an equivalent level to that of a display device for performing only transmission type display.

A second object of the present invention is to provide a liquid crystal display having an optimum structure for suppressing the area of the nondisplay region and the loss of the light as much as possible and improving the display viewability and the image quality of the reflection type display and the transmission type display and which can be easily produced.

A liquid crystal display of a first aspect of the present invention has a display panel comprised of a substrate formed with a pixel region having a reflection region for reflection type display and a transmission region for transmission type display and a substrate formed with a color filter located corresponding to the pixel region arranged facing each other across a liquid crystal layer, wherein the color filter located corresponding to the reflection region is formed under the same condition as that for the color filter located corresponding to the transmission region. Further, the color filter located corresponding to the reflection region is formed with one or more openings.

The liquid crystal display according to the present invention having the above configuration performs the display at the time of reflection type display using as the display light the light reflected in a state colored by being passed through the color filter and the light reflected in a state not colored by being passed through the opening constituting region where the color filter is not formed. Further, since the present invention performs the display by the light having a small amount of attenuation since it passes through the openings, that is, does not pass through the color filter, the reflectance is raised, and the luminance and the color reproducibility in the reflection type display are improved. Further, by adjusting the size of the opening for passing the light therethrough, the reflectance, luminance, etc. of the light in the reflection type display are adjusted.

Accordingly, since a liquid crystal display according to the present invention can adjust the reflectance, luminance, etc. in the reflection type display by adjusting the size of the opening, it becomes unnecessary to form the color filter corresponding to the reflection region under conditions different from those for the color filter corresponding to the transmission region, and it becomes possible to form the same under the same conditions, specifically by the same thickness and the same material. For this reason, according to the present invention, the color filter for the transmission region and the color filter for the reflection region can be formed by the same steps, and provision of a liquid crystal display able to perform the reflection type display with a high reflectance and a high luminance without increasing the production steps is enabled.

Further, since a liquid crystal display according to the present invention can adjust the reflectance, luminance, etc. by adjusting the size of the opening, an improvement of the reflectance, luminance, etc. in the reflection type display is enabled without narrowing the transmission region. Accordingly, according to the present invention, a structure stressing the transmission type realizing reflection type display of a high luminance by a high reflectance while having a large area for the transmission region and maintaining the luminance in the transmission type display at a high level can be employed. Due to this, the color reproducibility and the viewability in the transmission type display are improved.

According to the above present invention, a condensing portion is provided in the liquid crystal display panel, and the display light used for the transmission type display is condensed to increase the luminance of the display light. Due to this, even if the area of the transmission region is reduced, a sufficient luminance of the transmission type display can be secured, so higher definition can be coped with and the transmittance can be set low. Specifically, the transmittance is set at a minimum 4 percent.

Alternatively, due to the absorption effect of the component layers of the display panel, the transmittance becomes 10 percent or less.

Alternatively, low temperature polycrystalline silicon is used, the size of a thin film transistor TFT for every pixel is reduced, and the reflection region and the reflectance are improved. Alternatively, a reflection film made of a metal having a high reflectance is formed or a flat reflection film is formed to further improve the reflection luminance.

Alternatively, the color filters are provided for only the transmission region, only the transmission type display performs the color display having a high viewability, and the reflection type display performs a black and white display sufficient for displaying character. Due to this, there is no longer any reduction of the light due to the absorption at the color filters at the reflection region. Further, in the case of the black and white display, the pixels for displaying the three colors R, G and B are all used for the black and white display, so the reflection luminance is further improved.

Specifically, the reflectance can be set within a range from 1 percent to 30 percent.

The liquid crystal display of the first aspect of the present invention is a liquid crystal display including a plurality of pixel regions arranged in a matrix between a first substrate and a second substrate, a plurality of gate lines connecting the plurality of pixel regions and selecting a pixel region for display, and a plurality of data signal lines connecting the plurality of pixel regions and transmitting image data to the pixel region to perform the display, wherein each pixel region has a reflection region for display by reflecting light from the outside and a transmission region for display by passing light from an internal light source arranged in parallel; in each pixel region, color filters are provided on the first substrate at locations corresponding to the reflection region and the transmission region; color filters of adjacent pixel regions are superimposed at a boundary region; and an uncolored region is formed at part of the corresponding region of the reflection region.

Preferably, a data signal line has formed on it between the first and second substrates a spacer for controlling a gap between the first and second substrates.

Alternatively, a region where a data signal line and a gate line intersect has formed at it between the first and second substrates a spacer for controlling a gap between the first and second substrates.

Alternatively, the uncolored region is formed at a location of the color filters corresponding to a portion other than the regions where the spacers of the reflection region are formed and the superimposed regions. Preferably, the uncolored region is formed at a location of the color filters corresponding to substantially the center of the reflection region. Alternatively, the, uncolored region includes an opening.

A liquid crystal display of a third aspect of the present invention is a liquid crystal display including a plurality of pixel regions arranged in a matrix between a first substrate and a second substrate, a plurality of gate lines connecting the plurality of pixel regions and selecting a pixel region for display, and a plurality of data signal lines connecting the plurality of pixel regions and transmitting image data to the pixel region for display, wherein each pixel region has a reflection region for display by reflecting light from the outside and a transmission region for display by passing the light from an internal light source arranged in parallel; each pixel region is provided with color filters at locations on the first substrate corresponding to the reflection region and the transmission region; the first substrate is provided between the color filters of adjacent pixel regions with a light blocking film for blocking the light striking regions other than the pixel regions; and an uncolored region is formed at part of the corresponding regions of the reflection region.

Preferably, a data signal line has formed on it between the first and second substrates a spacer for controlling a gap between the first and second substrates. Suitably, the uncolored region is formed at a location of the color filters corresponding to a portion other than a region where the spacer of the reflection region is formed. Alternatively, the uncolored region includes an opening.

Alternatively, a region where a data signal line and a gate line intersect has formed at it between the first and second substrates a spacer for controlling a gap between the first and second substrates. Preferably, the color filters are provided with a light blocking film at a location corresponding to a region of the reflection region where the spacer is formed. Suitably, the uncolored region is formed at a location of the color filters corresponding to a portion other than a region where the spacer of the reflection region is formed. Alternatively, the uncolored region includes an opening.

According to the second aspect of the present invention, color filters of adjacent pixel regions are superimposed, a data signal line of a lower portion of the superimposed portion is blocked from light, a spacer between the substrates is formed on the data signal line at the reflection region, an uncolored region is formed at the color filters, and a white color is blended. Alternatively, a spacer is formed at a portion where a data signal line and a gate line intersect. Due to this, a nondisplay region due to the region where the spacer was formed and a region of abnormal liquid crystal orientation around the spacer is suppressed as much as possible, reflection on the data signal line is prevented, an increase of capacitance between a gate line and a data signal line is suppressed, and thus the luminance of the reflection type display is improved.

Further, according to the third aspect of the present invention, the light blocking film is formed between the color filters of the adjacent pixel regions to block light from the data signal line, the spacer between the substrates is formed on the data signal line in the reflection region, and the uncolored region is formed in the color filters and the white color is blended. Alternatively, an inter-substrate spacer is formed at the intersecting portion of the data signal line and the gate line, the light blocking film for blocking light from the spacer is provided in the color filters, and the uncolored region is formed in the color filters. Due to this, the nondisplay region due to the spacer is suppressed as much as possible, reflection on the data signal line is prevented, the increase of the capacitance between the gate line and the data signal line is suppressed, and the luminance of the reflection type display is improved.

### BRIEF DESCRIPTION OF THE DRAWINGS

FIG. 1 is a partial plan view of a structure of a display panel of a liquid crystal display according to a first embodiment of the present invention.

FIG. 2 is a sectional view of the structure of a display panel of a liquid crystal display according to the first embodiment of the present invention.

FIG. 3 is an equivalent circuit diagram of a pixel region.

FIG. 4 is a sectional view of an example of the structure of a thin film transistor in a liquid crystal display according to the first embodiment of the present invention.

FIG. 5 is a plan view of an example of a layout of pixels in a liquid crystal display according to the first embodiment of the present invention.

FIG. 6 is a plan view of another example of the layout of pixels in a liquid crystal display according to the first embodiment of the present invention.

FIG. 7 gives measurement data of reflectances and transmittances of liquid crystal displays using TFTs formed by Poly-Si and TFTs formed by a-Si.

FIG. 8A and FIG. 8B are views for explaining openings formed in color filters formed so as to be located corresponding to the pixel region.

FIG. 9A to FIG. 9D are views for explaining openings of other shapes.

FIG. 10 is a view of a backlight and a condensing optical system thereof in a liquid crystal display according to the first embodiment of the present invention.

FIG. 11 is a perspective view of the backlight and the condensing optical system thereof shown in FIG. 10.

FIG. 12 is a view of results of investigation of the lowest display luminance required for the display panel in a liquid crystal display according to the first embodiment of the present invention.

FIG. 13 is a graph of the relationship between the transmittance and the backlight luminance when maintaining a constant luminance on the surface of the display panel in a liquid crystal display according to the first embodiment of the present invention.

FIG. 14 is a view of results of measurement of the reflectance when using the entire surface of the reflection electrode of the display panel as a reflection film.

FIG. 15 is a view of a settable range of the transmittance and the reflectance in a liquid crystal display according to the first embodiment of the present invention.

FIG. 16A and FIG. 16B are views for explaining a method of measuring the reflectance.

FIG. 17 is a sectional view of another example of the structure of a thin film transistor in a liquid crystal display according to the first embodiment of the present invention.

FIG. 18 is a characteristic view for explaining a difference of the reflectance of a liquid crystal display formed with an opening and a liquid crystal display not formed with one.

FIG. 19 is a sectional view of the structure of the display panel in a liquid crystal display according to a second embodiment of the present invention.

FIG. 20 is a plan view of the layout of pixels in a liquid crystal display according to the second embodiment of the present invention.

FIG. 21 is a view of the arrangement of color filters in a liquid crystal display according to the second embodiment of the present invention.

FIG. 22 is a sectional view taken along a line a-a′ in FIG. 20 and shows the structure of a spacer portion of the display panel.

FIG. 23 is a sectional view taken along a line b-b′ in FIG. 20.

FIG. 24 is a plan view of the layout of pixels in a liquid crystal display according to a third embodiment of the present invention.

FIG. 25 is a view of arrangement of color filters in a liquid crystal display according to the third embodiment of the present invention.

FIG. 26 is a sectional view taken along a line c-c′ in FIG. 24 and shows the structure of the spacer portion of the display panel.

FIG. 27 is a sectional view taken along a line d-d′ in FIG. 24.

FIG. 28 is a plan view of the layout of pixels in a liquid crystal display according to a fourth embodiment of the present invention.

FIG. 29 is a view of the arrangement of color; filters in a liquid crystal display according to the fourth embodiment of the present invention.

FIG. 30 is a sectional view taken along a line e-e′ in FIG. 27 and shows the structure of the spacer portion of the display panel.

FIG. 31 is a plan view of the layout of pixels in a liquid crystal display according to a fifth embodiment of the present invention.

FIG. 32 is a view of the arrangement of color filters in a liquid crystal display according to the fifth embodiment of the present invention.

FIG. 33 is a sectional view taken along a line f-f′ in FIG. 31 and shows the structure of the spacer portion of the display panel.

FIG. 34 is a sectional view taken along a line g-g′ in FIG. 31 and shows the structure of the spacer portion of the display panel.

FIG. 35 is a view for explaining a liquid crystal display according to a sixth embodiment of the present invention and an equivalent circuit diagram of a liquid crystal display having a Cs-on-gate structure.

FIG. 36 is an equivalent circuit diagram of a liquid crystal display employing a driving method different from that of FIG. 35.

FIG. 37 is an equivalent circuit diagram of a liquid crystal display having a panel circuit of a low temperature polycrystalline silicon.

FIG. 38A shows a second example of the layout of pixel regions in a liquid crystal display according to a sixth embodiment of the present invention, while FIG. 38B is a view of the location of arrangement of the reflection region in the pixel region.

FIG. 39A and FIG. 39B are views of the location of arrangement of the reflectance region in each pixel region of a liquid crystal display according to the sixth embodiment of the present invention continuing from FIG. 38B.

FIG. 40 is a view of the location of arrangement of the reflectance region of each pixel region in a liquid crystal display according to the fifth embodiment of the present invention continuing from FIG. 38B.

### BEST MODE FOR CARRYING OUT THE INVENTION

Below, embodiments of the liquid crystal display of the present invention will be explained with reference to the attached drawings.

First Embodiment

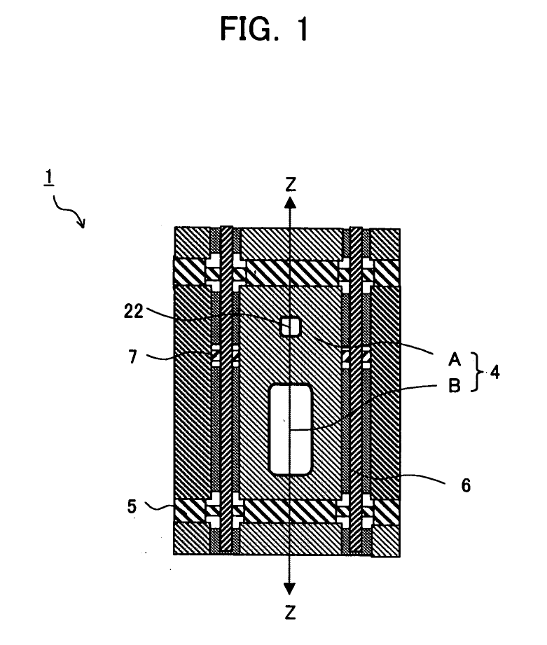

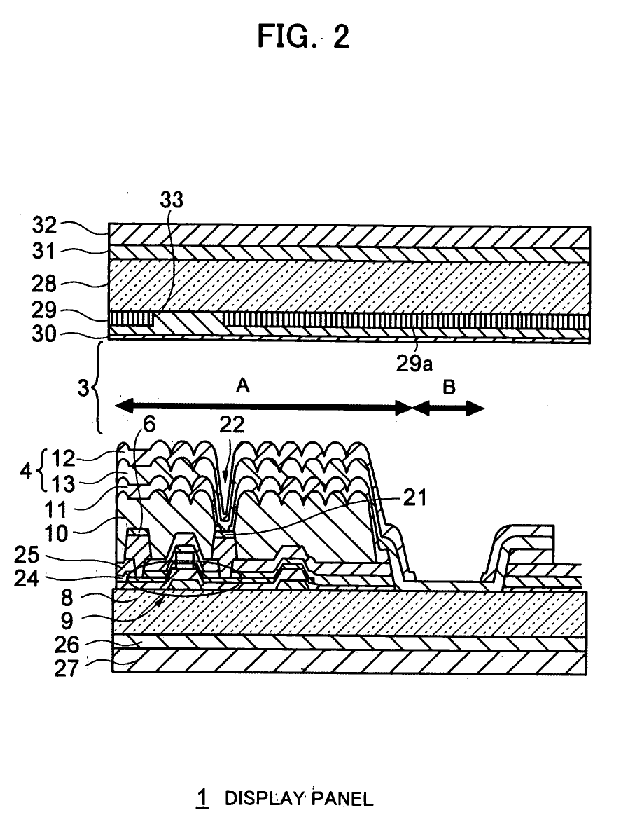

FIG. 1 is a plan view of one pixel's worth of a display panel 1 in the liquid crystal display of the present embodiment; and FIG. 2 shows the sectional structure of the display panel 1 along a Z-Z line in FIG. 1.

As shown in FIG. 2, the display panel 1 is constituted by a transparent insulating substrate 8 and a thin film transistor (TFT) 9 formed on that, a pixel region 4, etc., a transparent insulating substrate 28 arranged facing them and an overcoat layer 29 formed on that, color filters 29a, and an counter electrode 30 and a liquid crystal layer 3 sandwiched between the pixel region 4 and the counter electrode 30.

The pixel regions 4 shown in FIG. 1 are arranged in a matrix. A gate line 5 for supplying a scan signal to the TFT 9 shown in FIG. 2 and a signal line 6 for supplying a display signal to the TFT 9 are provided around each pixel region 4 perpendicular to each other, whereby a pixel portion is constituted.

Further, on the transparent insulating substrate 8 and the TFT 9 side, a storage capacitor use interconnect (hereinafter referred to as a “CS line”) 7 made of a metal film parallel to the gate line 5 is provided. The CS line 7 forms a storage capacitor CS with a connection electrode 21 explained later and is connected to the counter electrode 30.

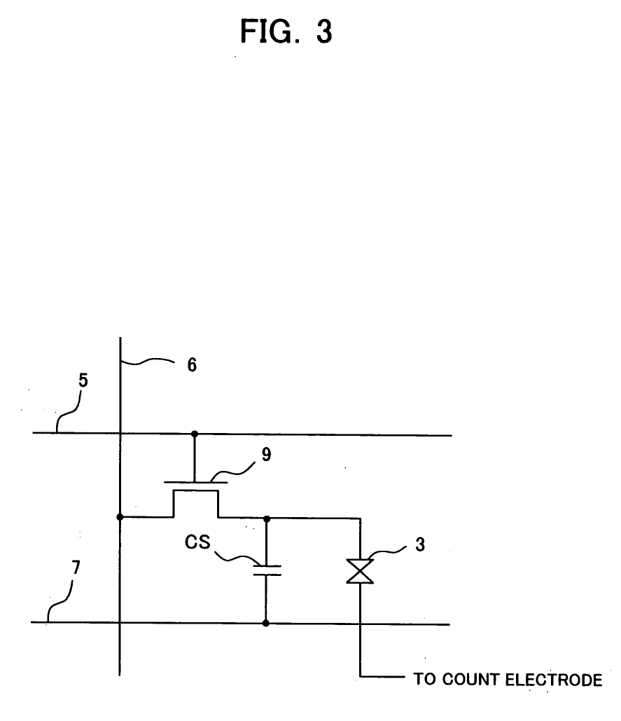

FIG. 3 shows an equivalent circuit of the pixel region 4 including the liquid crystal 3, TFT 9, gate line 5, signal line 6, CS line 7, and storage capacitor CS.

Further, as shown in FIG. 2, the pixel region 4 is provided with a reflection region A for reflection type display and a transmission region B for transmission type display.

The transparent insulating substrate 8 is formed by a transparent material such as glass. The transparent insulating substrate 8 is formed with the TFT 9, a scattering layer 10 formed on the TFT 9 via an insulating film, a flattening layer 11 formed on this scattering layer 10, a transparent electrode 13, and a reflection electrode 12 constituting the pixel region 4 having the reflection region A and the transmission region B explained above.

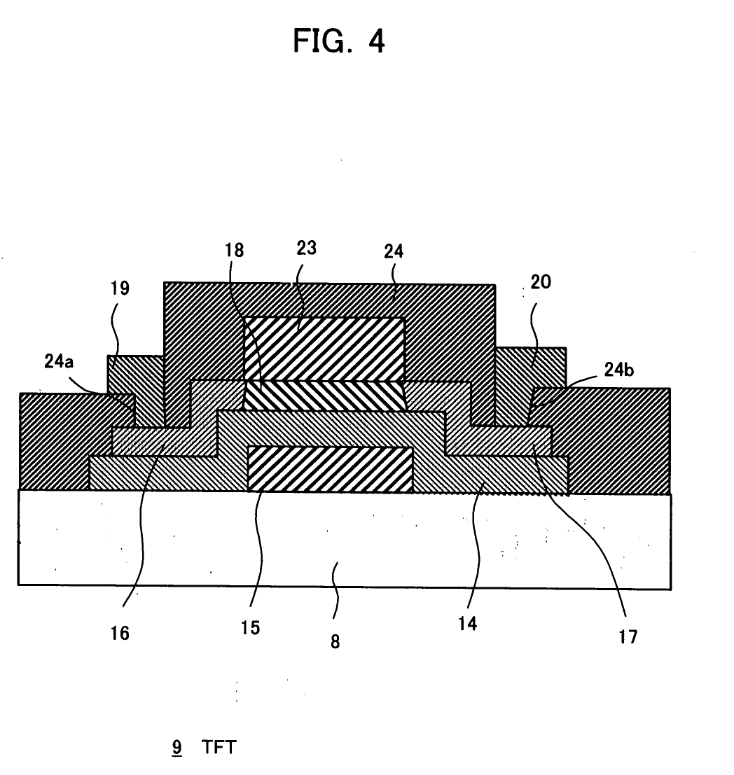

The TFT 9 is a switching element for selecting a pixel to be displayed and supplying a display signal to the pixel region 4 of the pixel. As shown in FIG. 4, the TFT 9 has for example a so-called bottom gate structure. A gate electrode 15 covered by a gate insulating film 14 is formed on the transparent insulating substrate 8. The gate electrode 15 is connected to the gate line 5, the scan signal is input from this gate line 5, and the TFT 9 turns ON/OFF in accordance with this scan signal. The gate electrode 15 is formed by forming a film of molybdenum (Mo), tantalum (Ta), or another metal or alloy by a method such as sputtering.

In the TFT 9, a pair of n⁺ diffusion layers 16 and 17 and a semiconductor film 18 are formed on the gate insulating film 14. One n⁺ diffusion layer 16 is connected to a source electrode 19 via a contact hole 24a formed in a first inter-layer insulating film 24, while the other n⁺ diffusion layer 17 is connected to a drain electrode 20 similarly via a contact hole 24b formed in the first inter-layer insulating film 24.

The source electrode 19 and the drain electrode 20 are obtained by patterning for example aluminum (Al). The source electrode 19 is connected to the signal line 6 and receives as input the data signal. The drain electrode 20 is connected to a connection electrode 21 shown in FIG. 2 and further is electrically connected with the pixel region 4 via the contact hole 22. The connection electrode 21 forms the storage capacitor CS with the CS line 7 via the gate insulating film 14. The semiconductor thin film layer 18 is a thin film of the low temperature polycrystalline silicon (poly-Si) obtained by for example CVD and is formed at a location matching with the gate electrode 15 via the gate insulating film 14.

A stopper 23 is provided just above the semiconductor thin film layer 15. The stopper 23 protects the semiconductor thin film layer 18 formed at the location matching with the gate electrode 19 from an upper side.

In the TFT 9, as explained above, when the semiconductor thin film layer 18 is formed by low temperature polycrystalline silicon, the electron mobility is larger in comparison with a case where the semiconductor thin film layer 18 is formed by amorphous silicon (a-Si), so the outer diameter size can be made smaller.

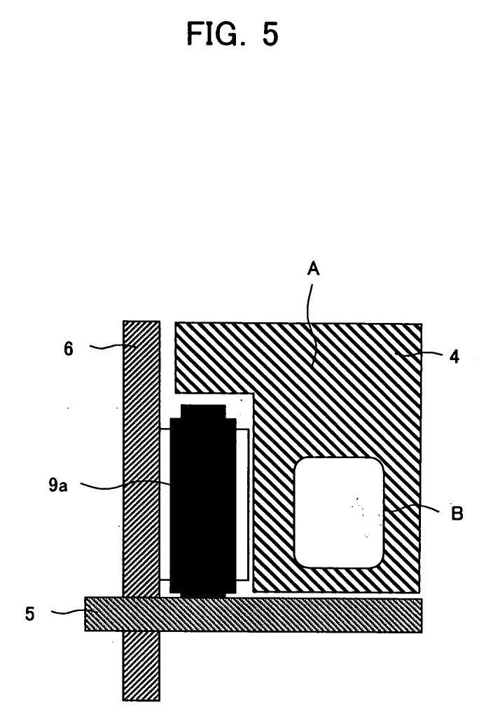

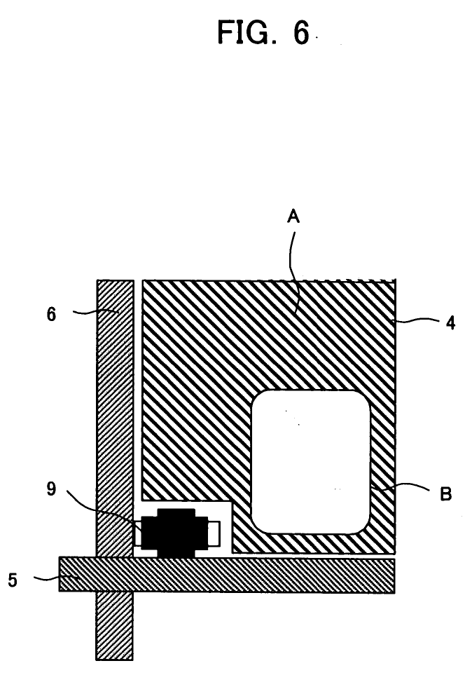

FIG. 5 and FIG. 6 are views diagrammatically showing the sizes of TFTs forming the semiconductor thin film layers 18 by a-Si and low temperature poly-Si.

As shown in FIG. 5 and FIG. 6, in a liquid crystal display using a TFT 9 forming the semiconductor thin film layer 18 by low temperature poly-Si, a large area of the pixel region 4 constituted by the reflection region A and the transmission region B can be secured. When the area of the reflection region A is approximately equal to that of the conventional display device, the area of the transmission region B can be increased and the transmittance of the entire display panel can be improved.

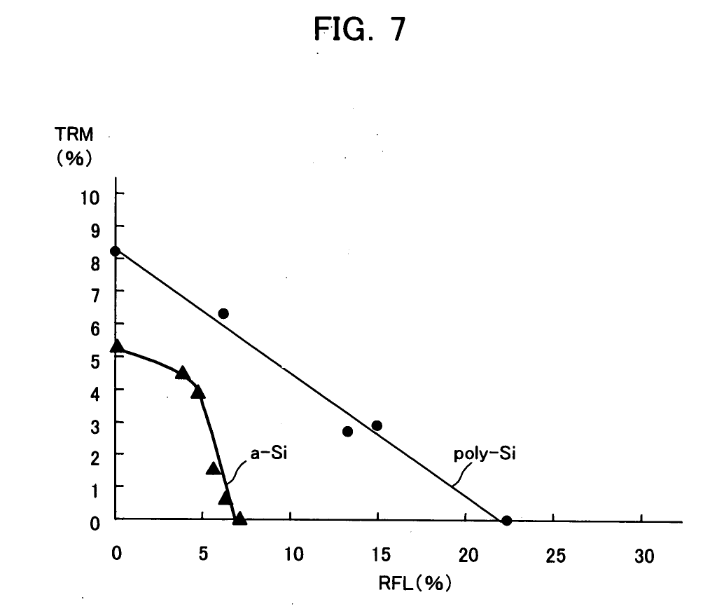

FIG. 7 is a view of a difference of the reflectance and the transmittance in dual reflection and transmission type liquid crystal displays using TFTs 9 forming the semiconductor thin film layers 18 by a-Si and low temperature poly-Si. In FIG. 7, the abscissa indicates the reflectance RFL, and the ordinate indicates the transmittance TRM.

The measurement values of the reflectance and the transmittance shown in FIG. 7 were obtained by changing the area of the opening acting as the transmission region B in FIG. 5 and FIG. 6. In the above measurement, the pixel region 4 has a silver reflection film, and the pixel size is 126 μm×42 μm.

As shown in FIG. 7, by applying low temperature poly-Si for the TFT 9, the reflectance of the liquid crystal display reaches about 25 percent at the maximum, and a transmittance of 8 percent at the maximum is obtained. On the other hand, when a-Si is used, the maximum reflectance is about 7 percent, and the maximum transmittance is about 5 percent.

The scattering layer 10 and the flattening layer 11 are formed on the TFT 9 via the first and second inter-layer insulating films 24 and 25. The first inter-layer insulating film 24 is formed with a pair of contact holes 24a and 24b for forming a source electrode 19 and a drain electrode 20.

The reflection electrode 12 is made of a metal film of rhodium, titanium, chromium, silver, aluminum and Chromel. The reflection region of the reflection electrode 12 is formed with relief shapes and is configured to diffuse and reflect the external light. Due to this, the directivity of the reflection light is eased and the screen can be viewed from a wide range of angles.

Particularly, when using silver (Ag) or the like, the reflectance in the reflection type display becomes high, and a reflection region A of a high reflectance can be obtained. For this reason, even if the area of the reflection region A is made small, the reflectance of the required level can be secured. Such a liquid crystal display reducing the reflection region will be referred to as a “micro reflection liquid crystal display”.

Further, the transparent electrode 13 is made of a transparent conductive film such as ITO.

These reflection electrode 12 and transparent electrode 13 are electrically connected to the TFT 9 via the contact hole 22.

The opposite surface of the transparent insulating substrate 8, that is, the surface where a not illustrated backlight serving as an internal light source is arranged, is provided with a ¼ wavelength plate 26 and a polarization plate 27.

Facing the transparent insulating substrate 8 and the components formed thereon, a transparent insulating substrate 28 formed by using a transparent material such as glass is arranged. The surface of the transparent insulating substrate 28 on the liquid crystal layer 3 side is formed with color filter 29a and an overcoat layer 29 for flattening the surface of the color filters 29a. The surface of the overcoat layer 29 is formed with a counter electrode 30. The color filter 29a is a resin layers colored by a pigment or a dye and is configured by combining filter layers of for example red, green, and blue colors.

The color filter 29a is formed with an opening 33 as an uncolored region in a portion corresponding to the reflection region A.

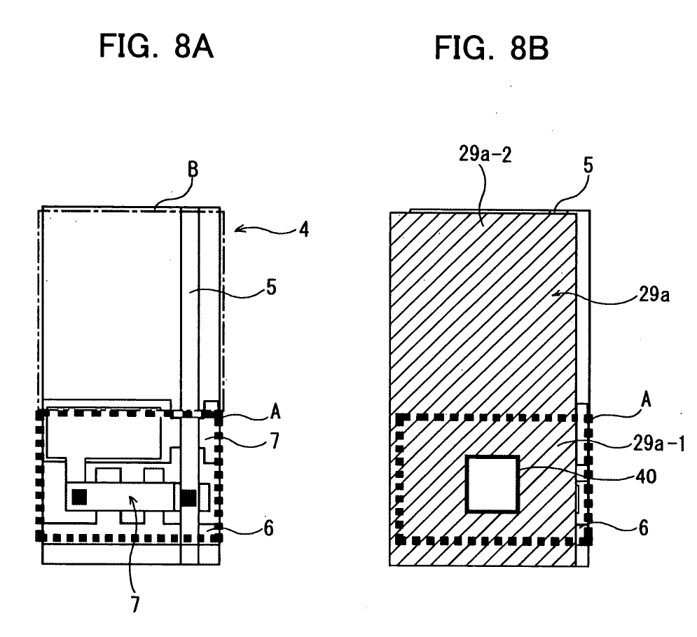

The opening 33 is a region provided since the color filter is not formed. When for example the region shown in FIG. 8A is used as the reflection region A, as shown in FIG. 8B, it is provided as a square opening at a location corresponding to approximately the center thereof and formed with a ratio of 10 percent to 90 percent with respect to the area of the entire color filter 29a-1 corresponding to the reflection region A.

The light passing through the opening 33 does not pass through the color filters 29a colored to different colors, so is not colored, and light having a small attenuation is obtained. Further, in the liquid crystal display, at the time of reflection type display, by using the light passed through this opening 33 as the display light together with the light passed through the color filters 29a, the reflectance, the luminance, and the color reproducibility in the entire reflection type display can be improved.

The light passed through the opening 33 explained above can be adjusted in amount according to the size of the opening 33. Accordingly, in the liquid crystal display, by changing the size of the opening 33 formed in the color filters 29a within the above range, the reflectance and the luminance in the reflection type display can be adjusted. For this reason, in the liquid crystal display, by forming the entire color filters 29a with a thickness and by a material different from those of the portion 29a-2 corresponding to the transmission region B, it becomes unnecessary to adjust the reflectance and the luminance in the reflection type display. Accordingly, in the liquid crystal display, the color filter 29a-1 and the color filter 29a-2 can be easily formed under the same conditions, specifically the same film thickness, the same material, and the same step, the reflectance in the reflection type display and further the luminance and the color reproducibility are improved without increasing the production steps, and therefore the viewability of the reflection type display can be improved.

Further, in the liquid crystal display, the luminance in the reflection type display can be improved by enlarging the opening 33 without raising the ratio of the reflection region A, so the size of the transmission region B can be maintained as it is. Accordingly, in the liquid crystal display, reflection type display of a high reflectance and a high luminance is realized, a structure stressing the transmission type having a large area of the transmission region B and maintaining the luminance in the transmission type display at a high level can be employed, and the color reproducibility and the viewability in the transmission type display can be improved.

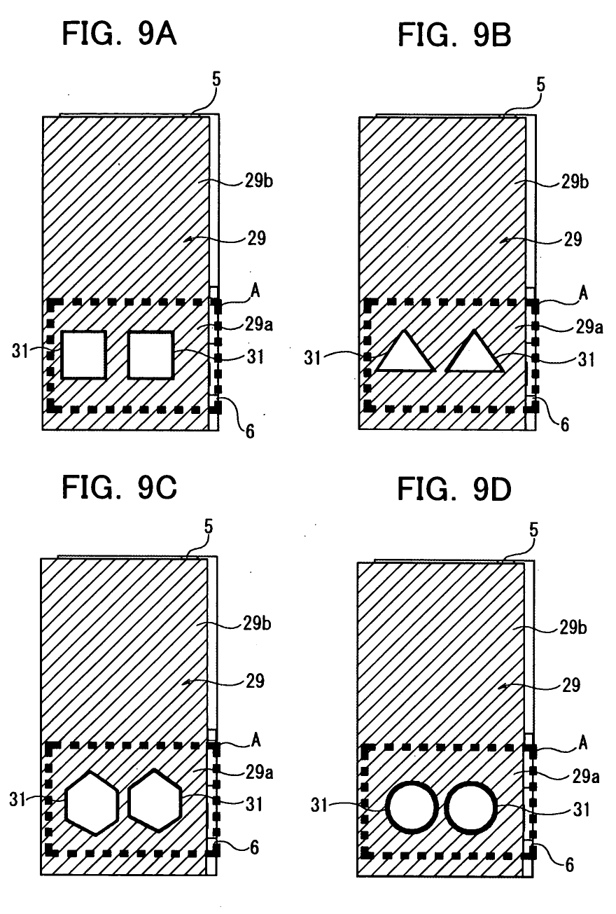

The opening 33 is not limited to the one opening exhibiting the square shape explained above, but, as shown in FIG. 9A to FIG. 9D, may be triangular, hexagonal, or other polygonal or circular and also may be two or more in number. However, when the opening 33 is given a polygonal shape, a difference arises in the amount of light between the incident light from the outside and the reflection light to the outside, so using a circular opening by which the amount of the reflection light becomes equal with respect to any incident light improves the efficiency of utilization of the reflection light. Accordingly, the opening 33 is preferably formed circular. Further, for a similar reason to why the circular opening 33 is good, even in the case where the opening 33 has a polygonal shape, a point symmetric polygon is preferred.

Further, the opening 33 can be formed at any place within the range of the color filter 29a-1 corresponding to the reflection region A other than the location corresponding to approximately the center of the reflection region A explained above, but when arranging this in the vicinity of the transmission region B, it becomes a cause of leakage of the light from the internal light source from the opening 33 at the time of transmission display, therefore, preferably it is formed so as to be located at approximately the center of the reflection region A.

The opening 33 is desirably formed to a size enabling easy pattern precision, for example 20 μm or more when for example the shape of the opening 33 is circular, when taking into consideration the fact that a negative pattern is used as the material of the color filter when forming the color filters 29a by photolithography and a 1 μm or more film thickness is required for achieving the function as a color filter. Further, the color filter 28 corresponding to the reflection region A cannot be eliminated, so the size of the opening 33 must be not more than the size of the reflection region A. Note that, if the photosensitivity and dimensional precision of the color filter material used in the photolithography are improved, further micro processing will become possible. Therefore, the size of the opening 40 is not limited to the above range and may be the opening width. Specifically, when the opening 33 is circular, it may be the diameter, and when the opening 33 is polygonal, a distance between opposite sides or a distance between the side and the vertex may be 1 μm or more.

Then, by providing the opening 33 in the color filter 29a-1 corresponding to the reflection region A as explained above, the reflection region A of a high reflectance can be obtained, for example, the area of the reflection region A for obtaining the viewability of at least the required level can be reduced, and, as a result, a liquid crystal display of a structure stressing the transmission type able to secure a large transmission region B can be easily realized. For this reason, the color reproducibility in the transmission type display is improved by a large transmission region B, and the viewability can be improved by the high luminance transmission type display.

The counter electrode 30 is, as explained above, formed on the overcoat layer 29 for flattening the surface of the color filters 29a formed with the opening 33 and is comprised of ITO or another transparent conductive film.

The opposite surface of the transparent insulating substrate 28 is provided with a ¼ wavelength plate 31 and a polarization plate 32.

The liquid crystal layer 3 sandwiched between the pixel region 4 and the counter electrode 30 is obtained by sealing a guest host liquid crystal mainly including nematic liquid crystal molecules having a negative dielectric anisotropy and containing a dichromatic dye in a predetermined ratio. It is vertically oriented by a not illustrated orientation layer. In this liquid crystal layer 3, in a no-voltage state, the guest host liquid crystal is vertically oriented, while in a voltage application state, it shift to a horizontal orientation.

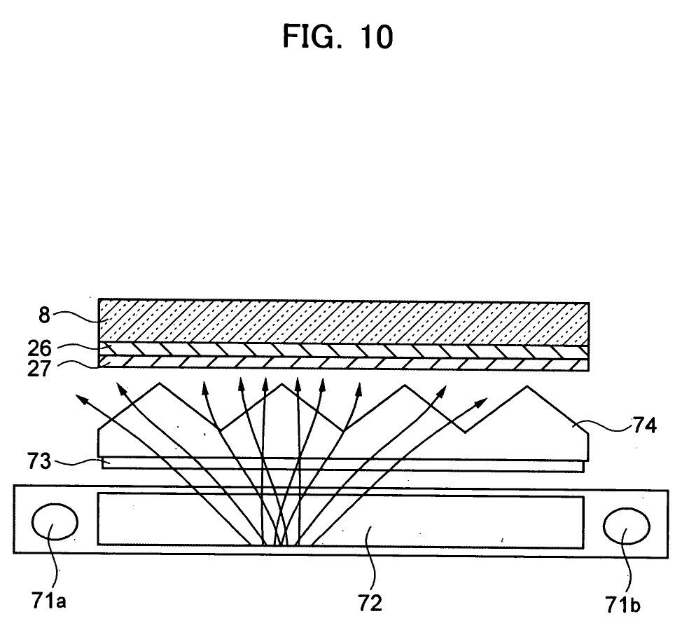

FIG. 10 shows a backlight and a condensing optical system thereof in the liquid crystal display according to the present embodiment.

In FIG. 10, 71a and 71b indicate backlights, 72 a light guide plate, 73 a diffusion plate, and 74 a lens sheet.

The backlights 71a and 71b are constituted by for example cold cathode fluorescent tubes. The light guide plate 72 guides light of the backlights 71a and 71b to the display panel 1. The diffusion plate 73 forms a relief surface. Due to this, the light of the backlights 71a and 71b is uniformly irradiated to the display panel 1. The lens sheet 74 condenses the light diffused by the diffusion plate 73 to the center of the display panel 1. The light condensed by the lens sheet 74 passes through the transmission region B via the polarization plate 27, the ¼ wavelength plate 26, and the transparent substrate 8.

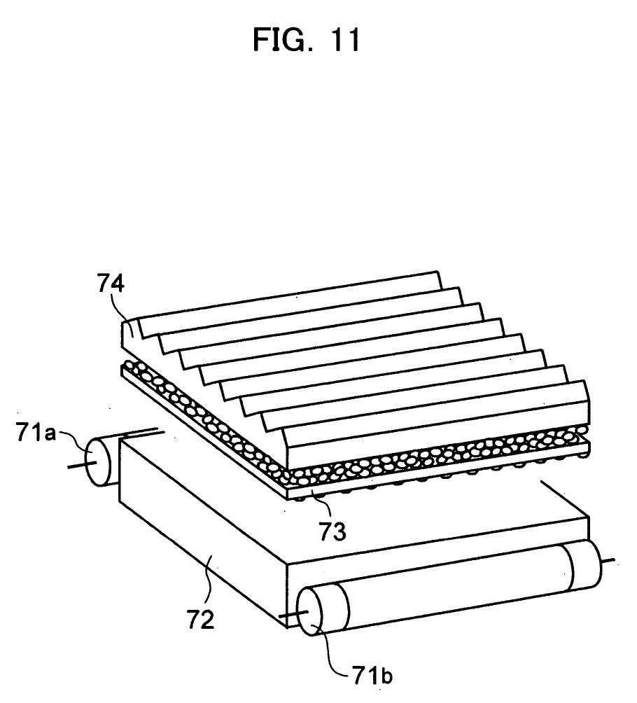

FIG. 11 is a perspective view of the backlight and the condensing optical system thereof shown in FIG. 10.

The lens sheet 74 has a condensing function, so loss due to scattering of the light diffused by the diffusion plate 73 is suppressed, and the luminance of the illumination light is raised.

As explained above, conventionally, a liquid crystal display has been prepared with a definition within a range from 100 ppi to 140 ppi. Since the definition was low, the aperture ratio of the transmission region B could be relatively largely formed. Specifically, at least 50 percent could be secured as the aperture ratio when designed for 140 ppi. Due to this, the conventional transmittance became 5 percent.

Note that the transmittance in a liquid crystal display is generally regarded as one-tenth of the aperture ratio of the transmission region B. The aperture ratio of the transmission region B is defined as the ratio of the transmission region B with respect to the area of the entire pixel region 4.

The transmittance was set at one-tenth of the aperture ratio of the transmission region B because the light from the backlights is absorbed and reflected by the transparent insulating substrates 8 and 28, the first and second inter-layer insulating films 24 and 25 formed on the TFT 9, the liquid crystal layer 3, the polarization plates 27 and 32, and the ¼ wavelength plates 26 and 31 constituting the display panel 1.

Concerning an increase in definition to 200 ppi, for example, the pixel size becomes a small 126 μm×42 μm. Further, due to restrictions in the design of the liquid crystal pixel, for example, the minimum width or pitch of the signal lines and the gate lines being not less than 5 μm, the area of the transmission region B becomes small. Specifically, the aperture ratio becomes 40 percent at the lowest.

The ratio of the area of the reflection region A with respect to the area of the entire pixel region 4, that is, the aperture ratio of the reflection region A, becomes 60 percent or less when the reflection region A occupies the pixel region 4 other than the transmission region B. The aperture ratio of the reflection region A cannot be reduced to 0 percent. From this, the aperture ratio of the reflection region A the least required for a dual reflection and transmission type liquid crystal display is determined within a range from 1 percent to 60 percent.

In order to deal with the increase in definition while securing the luminance of the transmission type display, for example, the luminance of the backlights 71a and 71b can be increased by 25 percent, but the power consumption of the liquid crystal display increases.

Therefore, when the lens sheet 74 explained above is used, it becomes possible to deal with the increase in definition without increasing the power consumption of the backlights 71a and 71b. Specifically, the luminance of the backlights 71a and 71b can be raised to 500 cd/m² to 25000 cd/m² from the usual range from 400 cd/m² to 20000 cd/m².

Accordingly, in the present embodiment, in the case of a liquid crystal display having a high definition of 150 ppi or more, a micro reflection structure liquid crystal display can set the transmittance at to as low as 4 percent in order to secure the transmission luminance.

On the other hand, in order to deal with the increase in definition and not increase the luminance of the backlights 71a and 71b, the best choice is to set the transmittance to the minimum 4 percent. The reason for this will be explained below.

In order to perform a display by liquid crystals, the surface luminance of the display panel 1 must be set within a certain range.

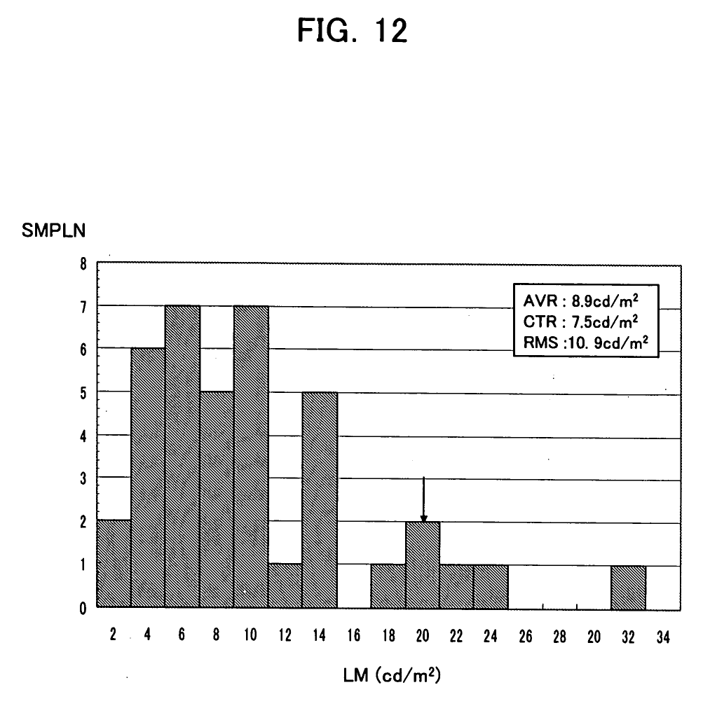

FIG. 12 is a view of the results of investigation showing the minimum luminance required for the display panel surface and shows the results of investigation of the number of people able to recognize the character display when the display luminance changes within a range from 2 to 34 cd/m². In FIG. 12, the abscissa indicates the luminance LM, and the ordinate indicates a sample number SMPLN. Note that, in this case, as shown in FIG. 12, an average value (AVR) is 8.9 cd/m², the center value (CTR) is 7.5 cd/m², and the RMS is 10.9 cd/m².

According to FIG. 12, if the surface luminance is 20 cd/m² or more, 90 percent or more of people can recognize the character display. Further, the fact that, if it is not more than 1000 cd/m², people can discriminate the characters has been known.

Accordingly, when performing a display by liquid crystals, the surface luminance of the display panel 1 must be maintained at 20 cd/m² to 1000 cd/m².

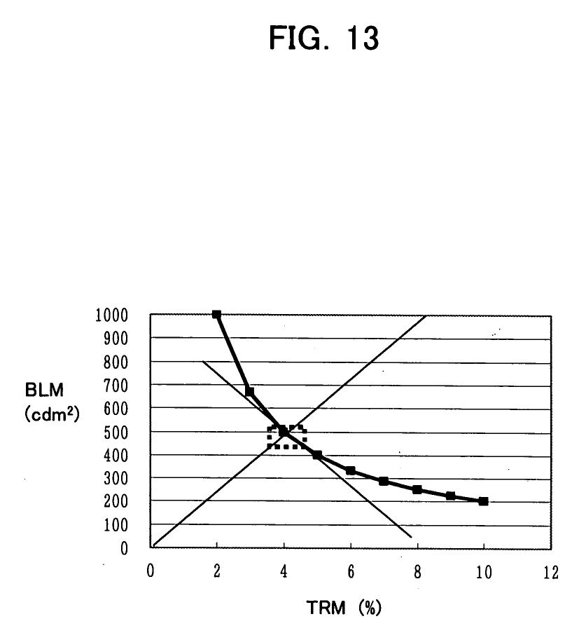

When the surface luminance of the display panel 1 is maintained at 20 cd/m², this means that a product of the transmittance of the display panel 1 and the luminance of the backlight is 20 cd/m². Accordingly, the relationship between the transmittance and the luminance of the backlights can be expressed by an inverse proportional function as shown in FIG. 13. In FIG. 13, the abscissa indicates the transmittance TRM, and the ordinate indicates the luminance BLM of the backlights.

In order to keep the transmittance and the luminance of the backlights to the minimum as much as possible, the location where a tangential normal of a curve as shown in FIG. 13 intersects an origin of a coordinate system becomes the most desirable condition. Here, the transmittance is 4 percent. Namely, 4 percent becomes the value of the optimum transmittance in order to deal with an increase in definition.

The reason why the transmittance becomes 10 percent at most is that the light from the backlights is absorbed and reflected by the transparent insulating substrates 8 and 28, the first and second inter-layer insulating films 24 and 25 formed on the TFT 9, the liquid crystal layer 3, the polarization plates 27 and 32, and the ¼ wavelength plates 26 and 31 constituting the display panel 1.

In the display panel 1, the polarization plates 27 and 32 are 50 percent polarization plates. The transmittance of each is 50 percent. The sum of the transmittances of the remaining parts, that is, the transparent insulating substrates 8 and 28, the first and second inter-layer insulating films 24 and 25 formed on the TFT 9, and the ¼ wavelength plates 26 and 31, is deemed to be 40 percent. Even if considering that all pixels can be passed through, the maximum transmittance of the display panel 1 becomes 50 percent (polarization plate)×50 percent (polarization plate)×40 percent (glass+TFT)=10 percent.

Accordingly, in the present embodiment, the range of the transmittance becomes 4 percent to 10 percent.

Concerning the reflectance, it is known that the illuminance observed outdoors becomes 2000 cd/m² on very dark days (with overcast thunderclouds and snow) and becomes 50000 1× (cd/m²) in clear state. Further, in the same way as that described above, in order for people to discriminate the character display, the display luminance must be 20 cd/m² or more. Accordingly, the reflectance of the display panel becomes 1 percent. The definition and measurement method of the reflectance will be explained later. This result coincides with the result of investigations by the inventors of the present application on the lowest illuminance by emitting light to a PDA from the front surface in a dark room.

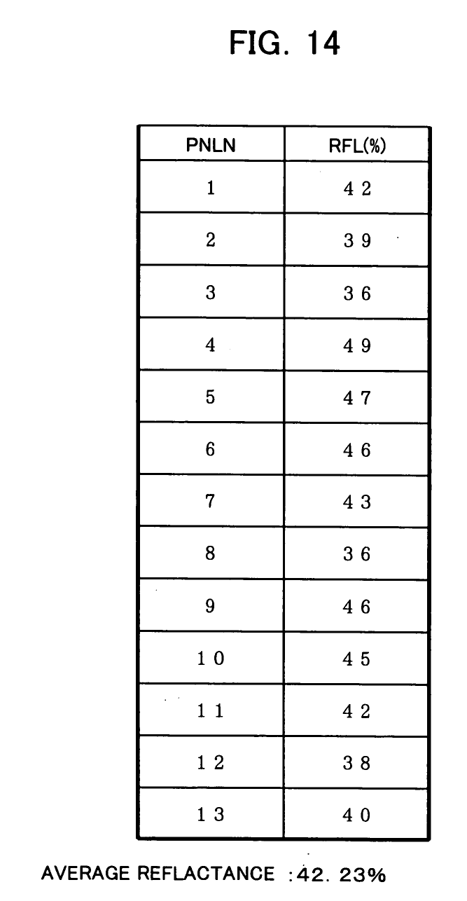

Regarding the maximum reflectance, it is known from measurement that 42 percent is the limit as the reflectance when for example Ag covers the entire surface of the reflection electrode 12. The graph shown in FIG. 14 shows the results of measurement of the reflectance when the entire surface of the reflection electrode 12 is used as the reflection surface. In FIG. 14, PNLN indicates the display panel number, and RFL indicates the reflectance. The average value of the measurement data shown in FIG. 14 is 42.23 percent. Accordingly, the display panel according to the present embodiment has an average reflectance of about 42 percent when the entire surface of the reflection electrode 12 is used as the reflection surface.

In actuality, the transmittance is 4 percent or more, that is, the aperture ratio is 40 percent to less than 100 percent. Namely, the area ratio of the reflection region is 60 percent or less. This being so, the maximum reflectance of the display panel 1 becomes 60 percent (reflectance)×42 percent (total surface reflectance)=25 percent. The reason for the aperture ratio being less than 100 percent is as follows. Namely, the signal line, gate line, and the transistor portions inside the pixel unavoidably block the transmission region. Therefore 100 percent cannot achieved as the aperture ratio, and it becomes less than 100 percent.

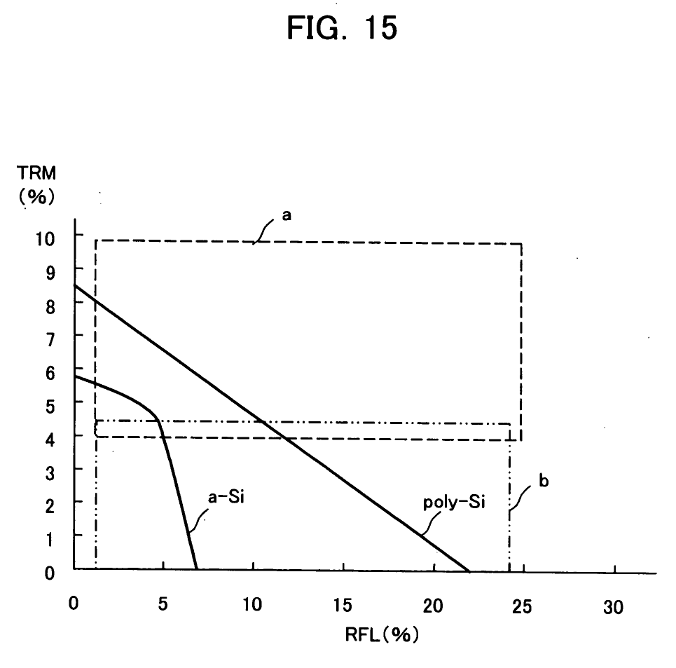

FIG. 15 is a view of a range of transmittance and reflectance able to be set in the liquid crystal display according to the first embodiment. In FIG. 15, the abscissa indicates the reflectance RFL, and the ordinate indicates the transmittance TRM. Further, in FIG. 15, a region indicated by the letter “a” indicates the range of transmittance and reflectance able to be set in a liquid crystal display according to the present embodiment, and a region indicated by the letter “b” indicates the range of transmittance and reflectance able to be set in a conventional liquid crystal display.

By the above liquid crystal display of the present embodiment, the reflectance in the display panel 1 can be set in a range from 1 percent to 25 percent, and the transmittance can be set at 4 percent to 10 percent, that is in the range of the region “a” shown in FIG. 15. By this, the liquid crystal display of the present embodiment can secure a luminance of the display light equivalent to that of a liquid crystal display performing only transmission type display, can secure the characteristics of a reflection type even in a high definition display of for example 200 ppi, and can realize a display having a high viewability even when the sunlight, illumination light, or other external light is dim.

Contrary to this, in a conventional liquid crystal display, the reflectance and the transmittance were set in the range of the region “b” shown in FIG. 15. Therefore, although a reflectance near that of the present embodiment can be secured, the transmittance is low, the luminance of the display light in the transmission type display is not sufficient, and the viewability is lowered.

Next, the method of measurement of the reflectance of the liquid crystal display explained above will be explained.

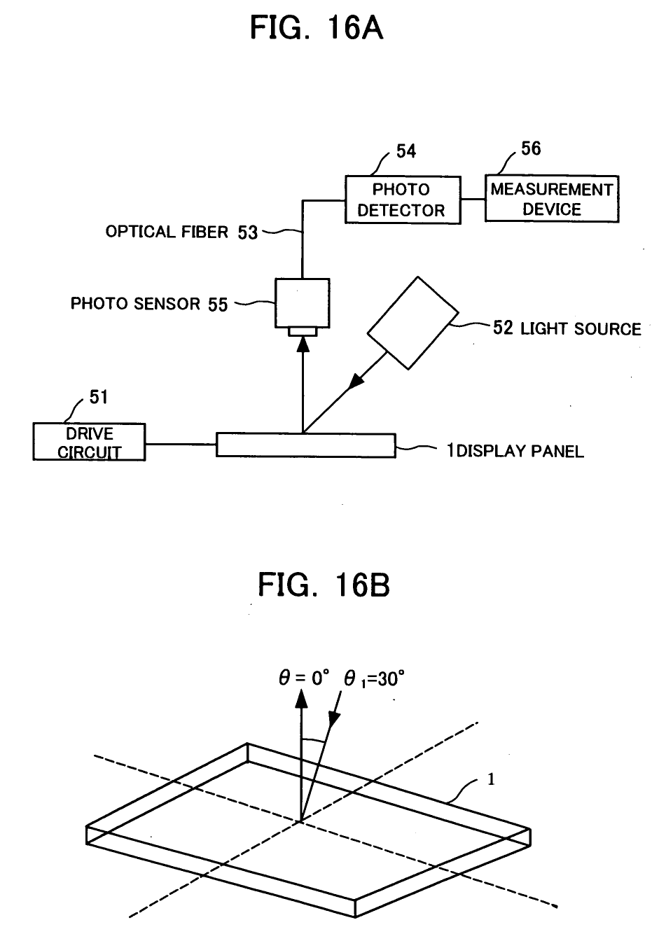

As shown in FIG. 16A, light is emitted from an external light source 52 to the liquid crystal display panel 1 having the above constitution. A drive circuit 51 supplies a suitable drive voltage to the display panel 1 to drive the display panel 1 so as to display white on the display panel 1. Then, the incident light is reflected at the reflection film in the display panel 1, is emitted, and strikes an optical sensor 55. An optical fiber 53 transmits the light received by the optical sensor 55 via the optical fiber 53 to a photo detector 54 and a measurement device 56. The measurement device 56 measures the output in the white display of the reflection light.

At this time, the light emitted from the external light source 52, as shown in FIG. 16B is emitted so that an incident angle θ₁ becomes 30° at the center of the display panel 1 and so that the reflection light reflected at the display panel 1 strikes the optical sensor 55 from the front surface, that is, the incident angle θ upon the optical sensor 55 becomes 0°. The reflectance of the reflection region A is found as shown in the following equation 1 using the output of the reflection light obtained in this way:

R=R (White)=(output from white display/output from reflection standard)×reflectance of reflection standard (1)

Here, the “reflection standard” is a standard reflection object whose reflectance is already known. When the incident light is constant, if comparing the amount of the reflection light from the measurement object with the amount of the reflection light from the reflection standard, the reflectance of the measurement object can be estimated.

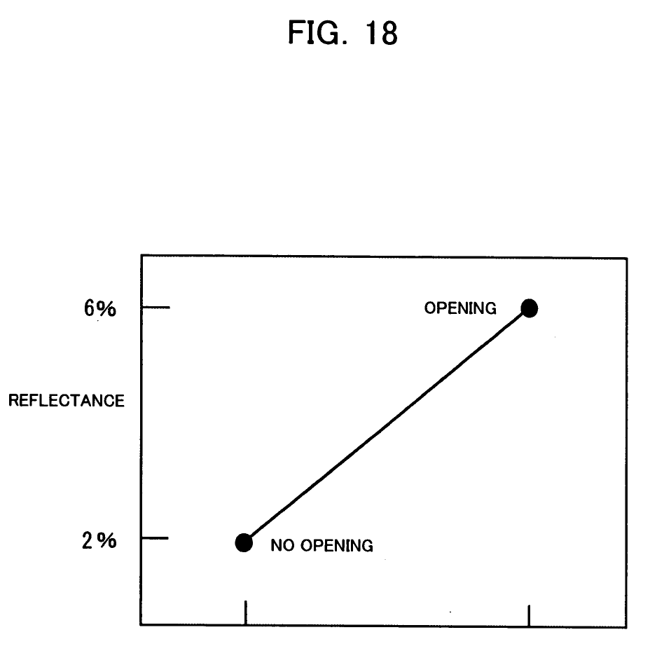

The results of measuring the reflectances for the case where the color filters 29a are formed with the opening 33 and the case where it is not formed with it are shown in FIG. 18. Note that the color filters 29a are formed under the same conditions as those for the color filter 29a portion, that is, with the same thickness and the same material, regardless of presence/absence of the opening 33. As shown in the figure, while the reflectance when the opening 33 is formed is a high 6 percent, the reflectance becomes 2 percent when the opening 33 is not formed. In this way, the reflectance is greatly improved when the opening 33 is formed in comparison with the case when it is not formed. Note that, in the measurement of this reflectance, a liquid crystal display having a pixel size of 190.5 μm×190.5 μm and a dot size of 93.5 μm×93.5 μm was used.

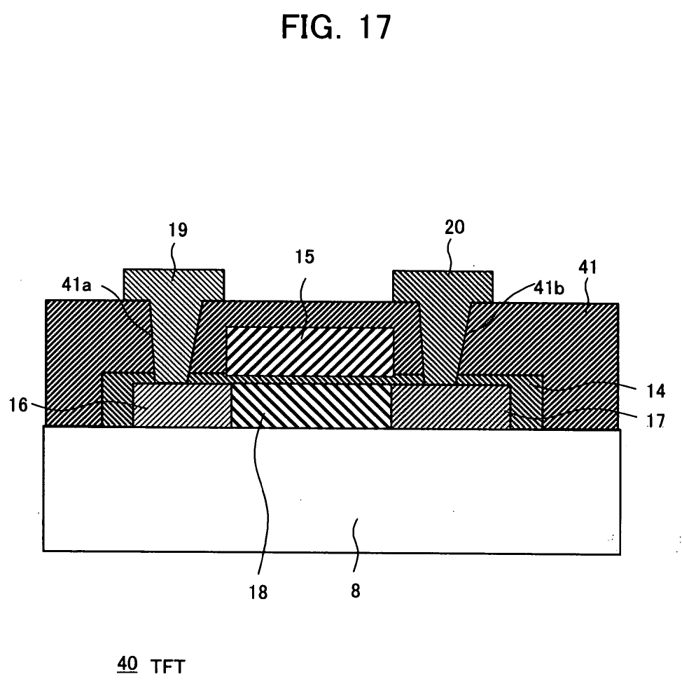

Note that the above explanation was given assuming that the TFT 9 had a bottom gate structure, but the TFT 9 is not limited to such a structure and may have a so-called top gate structure shown in FIG. 17. In FIG. 17, the same notations are used for components similar to those of the TFT 9 shown in FIG. 4, and explanations thereof are omitted.

In a TFT 40, a transparent insulating substrate 8 is formed with a pair of n⁺ diffusion layers 16 and 17 and a semiconductor thin film layer 18. These are covered by a gate insulating film 14. The gate insulating film 14 is formed with a gate electrode 15 at a location matching with the semiconductor thin film layer 18 and is covered by an inter-layer insulating film 41. The inter-layer insulating film 41 is formed with a source electrode 19 and a drain electrode 20, the source electrode 19 is connected to one n⁺ diffusion layer 16 via a contact hole 41a formed in the inter-layer insulating film 41, and the drain electrode 20 is connected to the n⁺ diffusion layer 17 via a contact hole 41b formed in the inter-layer insulating film 41.

According to the present embodiment, by condensing the light from the backlights by the lens sheet 74, the luminance of the backlights is improved, the transmittance is set at 4 percent to 10 percent, the reflectance is set in a range from 1 percent to 25 percent, and it becomes possible to deal with the reduction of the pixel size and the transmission region area along with the increased definition of display while securing a display light luminance equivalent to that of a display performing only transmission type display and a reflection display light luminance required for the display without increasing the power consumption of the backlights.

Second Embodiment

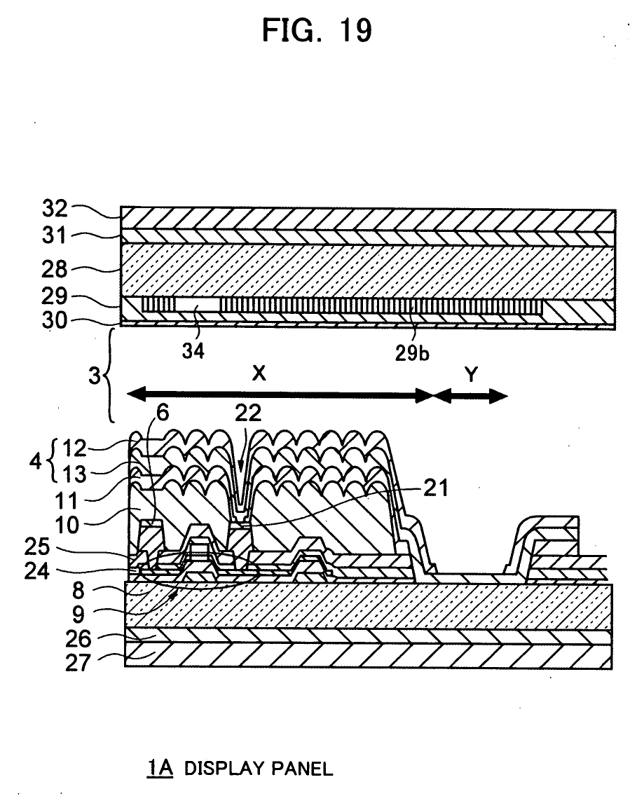

FIG. 19 is a sectional view of one pixel's worth of the structure of a display panel 1A in a liquid crystal display according to a second embodiment.

The display panel 1A of the second embodiment is similar to the first embodiment in the points that a color filter 29b is provided at a location corresponding to a reflection region X and the transparent region B and that an opening 34 serving as an uncolored region is formed at part of the corresponding region of the reflection region X, but is further constituted so that the color filters in adjacent pixel regions are superimposed at boundary regions.

The rest of the configuration is similar to that of the first embodiment explained above. Below, this configuration will be explained with reference to the drawings while focusing on the characterizing constitution of the second embodiment.

In the present embodiment, as shown in FIG. 19, a portion of the color filters 29a corresponding to the reflection region X is provided with an opening 34. The reflection light passing through the opening 34 is no longer attenuated by the color filter 29b, so the luminance of the reflection display light increases. Further, the reflection light passing through the opening 34a is not colored, so a white display is obtained.

The opening 34 here corresponds to the “uncolored region” of claim 1. Further, as an example, one opening is provided, but the number and the size of the openings can be freely set according to the luminance of the reflection display to be obtained.

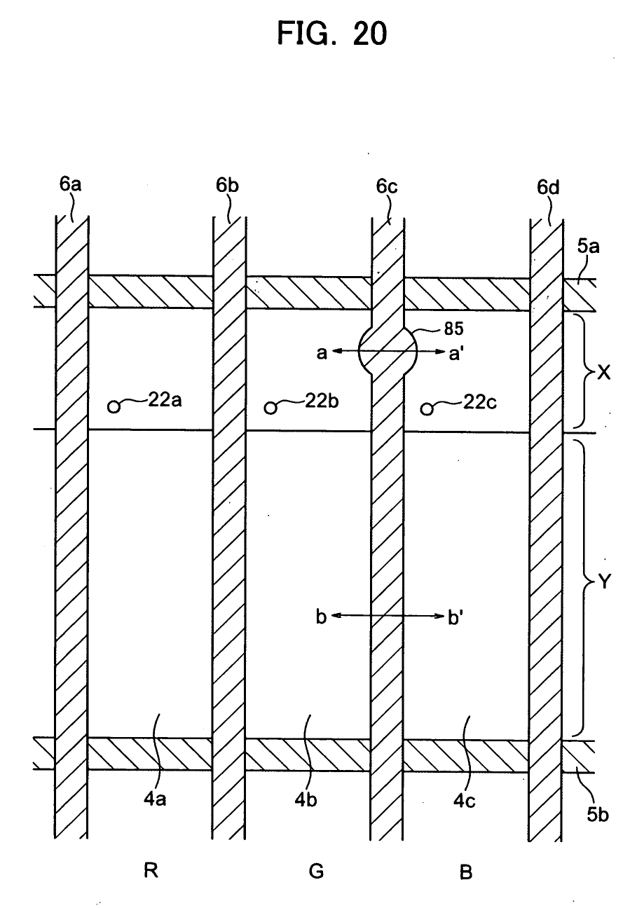

FIG. 20 is a plan view of an arrangement of interconnects in the three pixel regions 4a, 4b, and 4c each displaying one color pixel and covered by the color filters of red (R), green (G), and blue (B) to display red (R), green (G), and blue (B) colors.

As shown in FIG. 20, the pixel regions 4a, 4b, and 4c are arranged in a matrix, and gate lines 5a, 5b, and 5c for supplying scan signals to the TFT 9 shown in FIG. 19 and signal lines 6a, 6b, 6c, and 6d for supplying display signals to the TFT 9 are arranged at the periphery of the pixel regions so as to intersect each other.

Further, as shown in FIG. 20, the pixel regions 4b and 4c are provided between them with a spacer 85 on the signal line 6c in the reflection region X.

In the liquid crystal display, in order to control the cell gap and the thickness of the liquid crystal layer 3, keep the thickness of the liquid crystal layer 3 uniform, and prevent uneven display, it is necessary to provide spacers between the substrates 28 and 8. Particularly, in the display panel 1A of the present embodiment, the cell gaps of the reflection region X and the transparent region B are different. When the cell gap of the reflection region X is narrower and the cell gap of the transparent region B is broader, spacers are formed to raise the controllability of the cell gaps.

However, the places for forming the spacers become a problem. Conventionally, spacers were formed in contact holes 22a, 22b, 22c, or the like, but the spacers occupied considerable portions of the reflection region. Further, regions of abnormal liquid crystal orientation were caused around the spacers. Nondisplay regions unusable for display were produced.

In the present invention, in order to improve the display viewabilities of the reflection type display and the transmission type display, the nondisplay regions must be kept to the minimum.

Accordingly, in the present embodiment, the spacers are formed in regions which will not be used for the display. For example, in the reflection region X, a spacer 85 is formed on the signal line 6c.

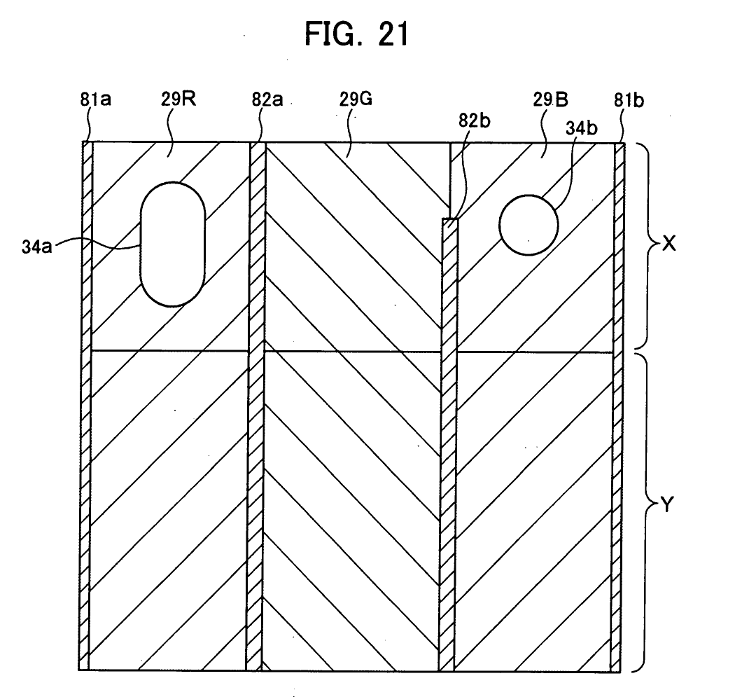

FIG. 21 is a plan view of the arrangement of the color filters in the display panel 1. The color filters 29R, 29G, and 29B are colored to the red (R), green (G), and blue (B) colors, arranged at locations matching with the pixel regions 4a, 4b, and 4c, and color the reflection display light and the transmission display light from the pixel regions 4a, 4b, and 4c for color display by the three primary colors of R, G, and B.

As explained above, in order to suppress the attenuation of the reflection display light due to the color filters and increase the luminance of the reflection display light, for example, the color filters 29R and 29B are provided with openings 34a and 34b of the shapes as illustrated. By adjusting the sizes of the openings 34a and 34b, it is possible to adjust the amounts of the light passing through the openings 34a and 34b and thereby adjust the reflection type display luminance. Further, the color filters 29R and 29B having the openings 34a and 34b formed therein can be easily produced without increasing the production steps.

As explained above, the number and shape of the opening are not limited to those in the above explanation and can be set according to need.

The signal lines 6a, 6b, 6c, and 6d shown in FIG. 20 reflect the light striking them from the outside. The reflection light is nondisplay light, so if it strikes the upper liquid crystal layer 3, there is a problem that the liquid crystal layer responds to it and uneven display is caused. In order to solve this problem, the signal lines 6a, 6b, 6c, and 6d may be shielded to prevent light from the outside from striking them.

In the present embodiment, as the method of blocking light from the signal lines 6a, 6b, 6c, and 6d, as shown in FIG. 21, adjacent color filters among the color filters 29R, 29G, and 29B are superimposed and the superimposed regions 82a and 82b blocking light from the signal lines 6a, 6b, 6c, and 6d.

When the red, green, and blue color filters 29R, 29G, and 29B are superimposed, the colors of the superimposed regions 82a and 82b become deeper and function as good shields.

Note that 81a and 81b are reflection edges of the color filters 29R and 29B. Further the color filters 29G and 29B are not superimposed at end portions on the reflection region X side of the boundary line of the color filters 29G and 29B corresponding to the region for formation of the lower spacer 85, that is, a light blocking film is not provided.

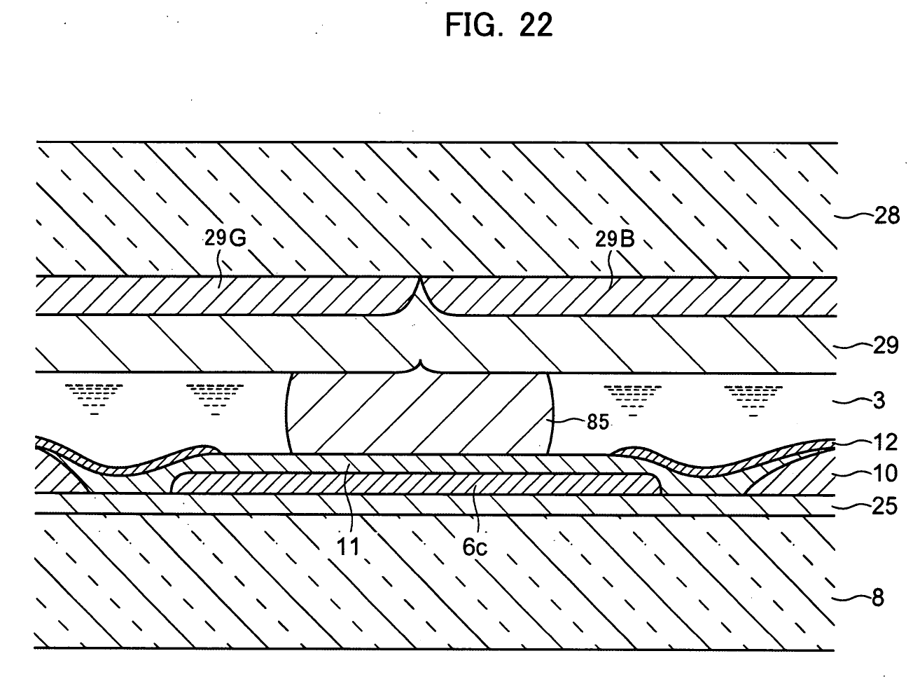

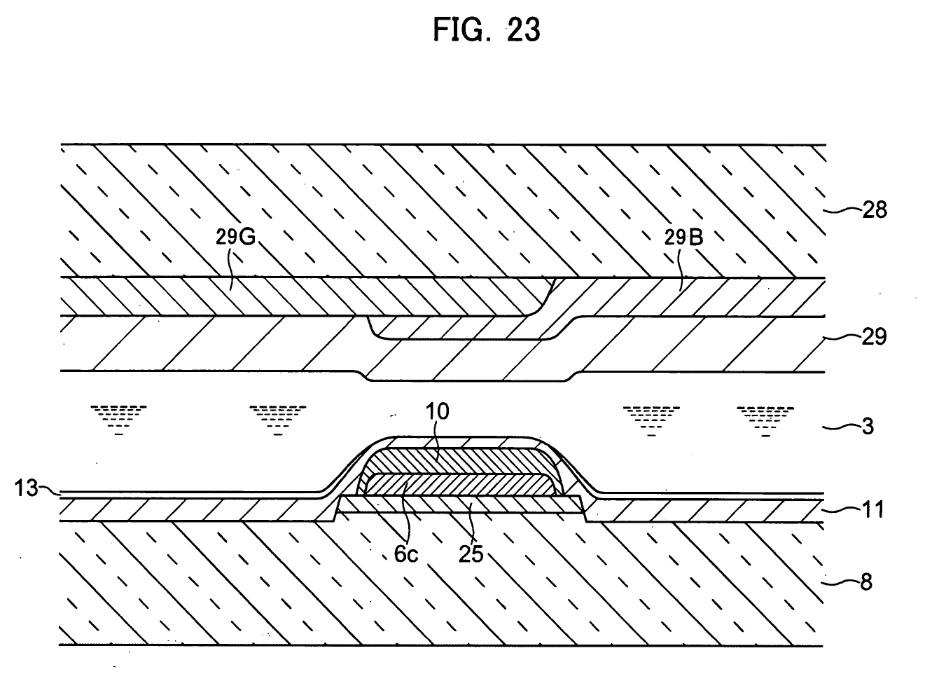

FIG. 22 is a sectional view of principal parts of the display panel 1A along a line a-a′ in FIG. 20. FIG. 23 is a sectional view of the principal parts of the display panel 1A along a line b-b′ in FIG. 20.

In FIG. 22 and FIG. 23, components similar to those of FIG. 19 use the same notations and overlapping explanations are omitted.

As shown in FIG. 22, a spacer 85 is formed on the signal line 6c via the transparent flattening layer 11. Further, as described above, the color filters 29G and 29B at the location corresponding to the spacer 85 are not superimposed. This is because the light reflected at the spacer 85 is blocked by the ¼ wavelength plate 31 provided above it, so the display is not hindered.

FIG. 23 shows the structure of a region where the spacer 85 is not formed. In FIG. 23, the color filters 29G and 29B are superimposed and block the ambient from striking the signal line 6c via the transparent flattening layer 11.

According to the present embodiment, the adjacent color filters 29b are superimposed to block light from the signal line 6 as shields. Further, the spacer 85 is formed on the signal line 6. Further, the color filters are formed with openings 34a and 34b to blend in the white color. Due to this, the color filters can be easily produced, the nondisplay regions due to the region occupied by the spacer and the regions of abnormal liquid crystal orientation around them are suppressed as much as possible, reflection on the signal line is prevented, the increase of the capacitance between the gate line and the data signal line is suppressed, and the luminance and the image quality of the reflection type display are improved.

Note that the above explanation was given by assuming that the TFT 9 had a bottom gate structure, but the TFT 9 is not limited to this and may have the top gate structure too.

Further, in the above explanation, the example of forming one spacer at one RGB color pixel was explained, but the present embodiment is not limited to this. The spacers may be arranged according to need.

Third Embodiment

A liquid crystal display of the third embodiment is a dual reflection and transmission type liquid crystal display having the same structure as the structure shown in FIG. 19.

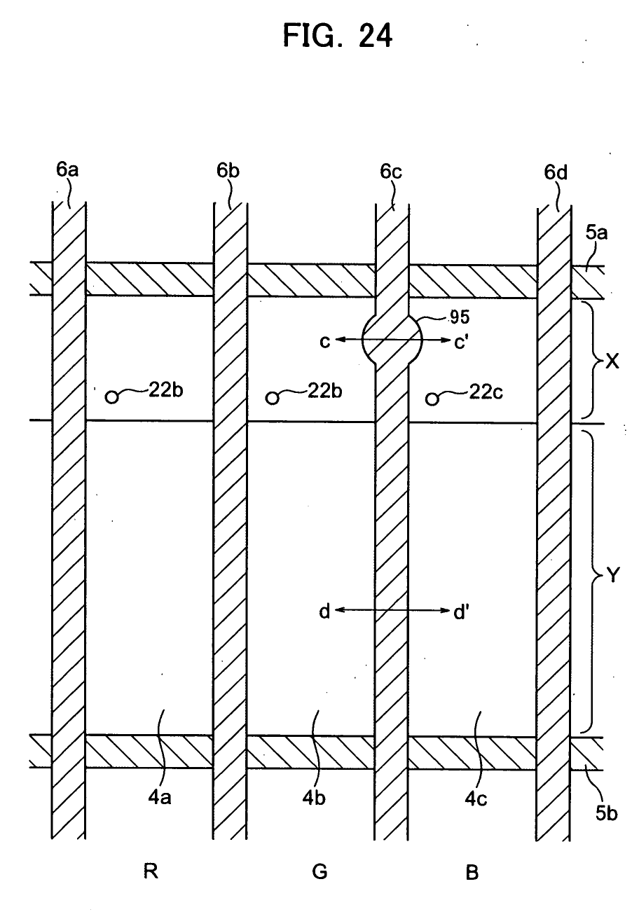

FIG. 24 is a plan view of the arrangement of interconnects in three pixel regions 4a, 4b, and 4c for displaying three colors R, G, and B.

The adjacent portions of the pixel regions 4a, 4b, and 4c are provided with gate lines 5a and 5b and signal lines 6a, 6b, 6c, and 6d arranged so as to intersect each other.

A spacer 95 is provided on the signal line 6c in the reflection region X between the pixel regions 4a and 4c.

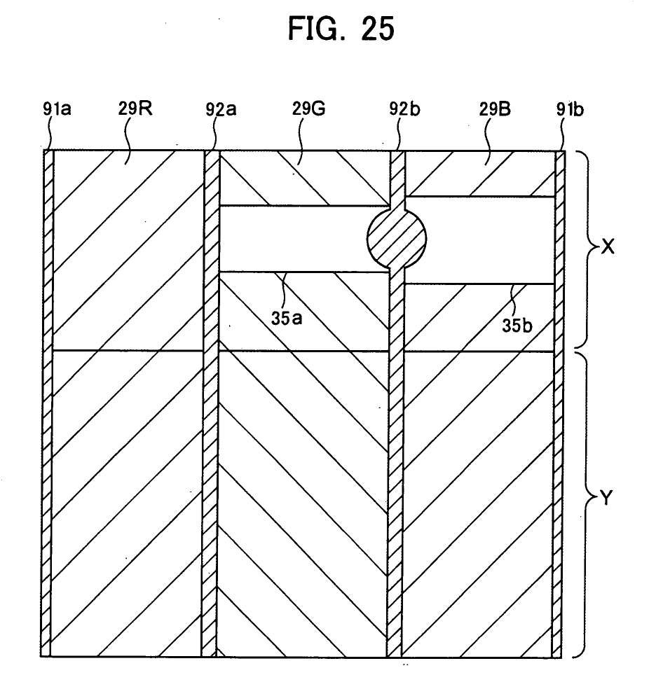

FIG. 25 is a plan view of the arrangement of color filters in the display panel 1A. The color filters 29R, 29G, and 29B are colored to the R, G, and B colors, arranged at locations matching with the pixel regions 4a, 4b, and 4c, and color the reflection display light and the transmission display light from the pixel regions 4a, 4b, and 4c for color display by the three primary colors R, G, and B. For example, the color filters 29G and 29B are provided with openings 35a and 35b having the illustrated rectangular shapes in the vicinity of the location corresponding to the spacer 95 and blend the white color. By adjusting the arrangement, size, and number of the openings 35a and 35b, it is possible to adjust the amounts of the light passing through the openings 35a and 35b and to thereby adjust the reflection type display luminance.

Note that the arrangement, number, and the size of the openings can be set according to need.

In order to prevent light reflection at the signal lines 6a, 6b, 6c, and 6d shown in FIG. 24, in the present embodiment, as shown in FIG. 25, the adjacent color filters 29R and 29G and 29G and 29B are, for example, formed between them with light blocking films 92a and 92b made of metal films such as chromium. These block light from the signal lines 6a, 6b, 6c, and 6d.

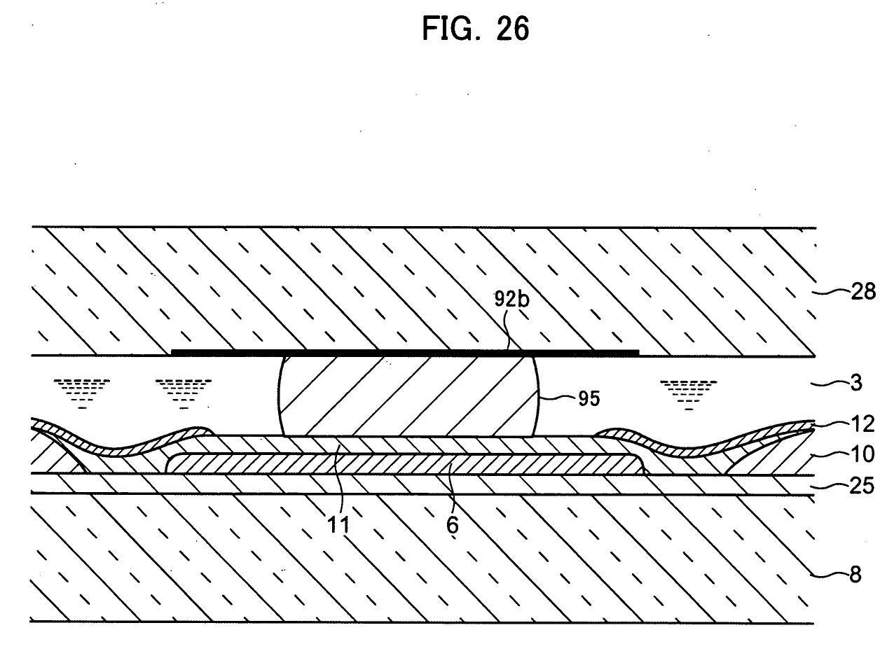

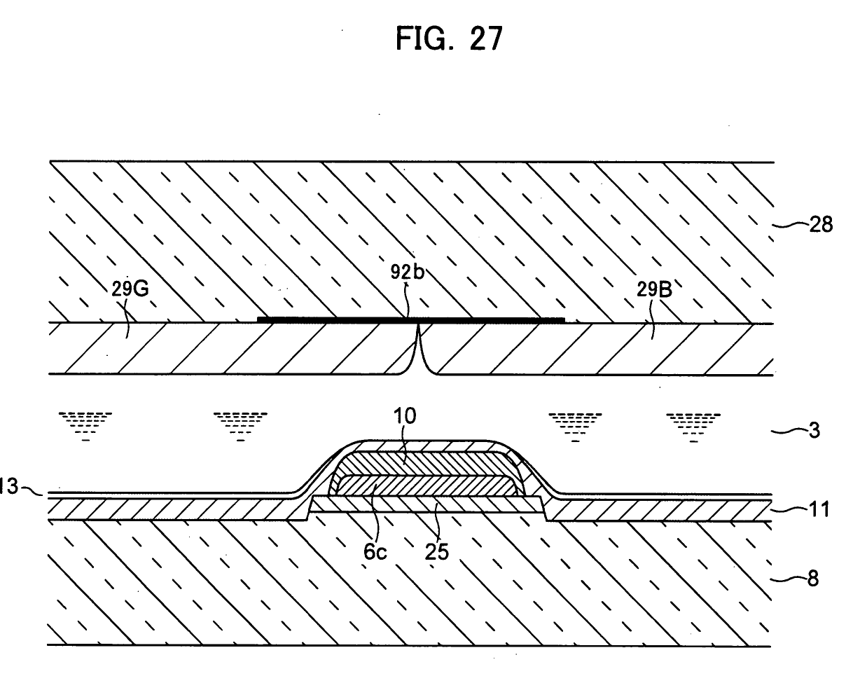

FIG. 26 is a sectional view of principal parts of the display panel 1A shown in FIG. 1 along a line c-c′ in FIG. 24. FIG. 27 is a sectional view of principal parts of the display panel 1A along a line d-d′ in FIG. 24.

In FIG. 26 and FIG. 27, components similar to those of FIG. 19 use the same notations.

As shown in FIG. 26, a spacer 95 is formed on the signal line 6c via the transparent flattening layer 11. The spacer 95 is formed over it with a metallic light blocking film 92b.

FIG. 27 shows the structure of the region where the spacer 95 is not formed. In FIG. 27, the color filters 29G and 29B are formed over them with the metallic light blocking film 92b which blocks the ambient light from striking the signal line 6c via the transparent flattening layer 11.

According to the present embodiment, the color filters are formed between them with a metallic light blocking film which blocks light from the signal line 6. Further, the spacer 95 is formed on the signal line 6. Further, the color filters are formed with openings 35a and 35b to blend in white color. Due to this, the metal film can be easily formed with openings of various shapes, the nondisplay region due to the spacer is suppressed as much as possible, reflection on the signal line is prevented, the increase of the capacitance between the gate line and the signal line is suppressed, and the luminance and the image quality of the reflection type display are improved.

Note that, at one RGB color pixel, the number of spacers is not limited to that of the above example.

Fourth Embodiment

The liquid crystal display of the fourth embodiment is a dual transmission and reflection type liquid crystal display having the same fundamental structure as that of the display panel 1A shown in FIG. 19.

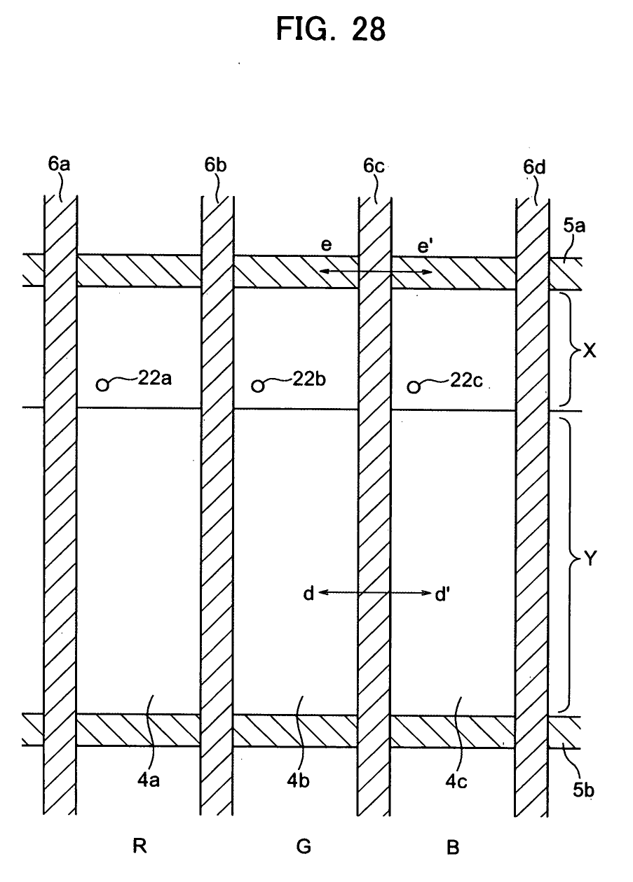

FIG. 28 is a plan view of the arrangement of interconnects in the three pixel regions 4a, 4b, and 4c for displaying three colors R, G, and B. In FIG. 28, the adjacent portions of the pixel regions 4a, 4b, and 4c are provided with the gate lines 5a and 5b and the signal lines 6a, 6b, 6c, and 6d arranged so as to intersect each other.

In the present embodiment, spacers are not provided on the signal line 6c, but, as will be explained later, are formed at the intersecting portions of the gate lines 5 and the signal line 6c.

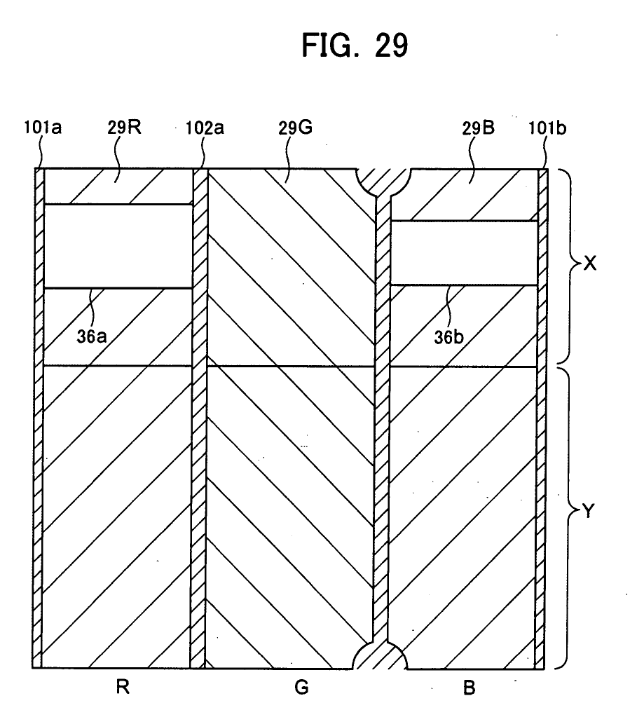

FIG. 29 is a plan view of the arrangement of the color filters in the display panel 1. The color filters 29R, 29G, and 29B are colored to the R, G, and B colors, arranged at the locations matching with the pixel regions 4a, 4b, and 4c, and color the reflection display light and the transmission display light from the pixel regions 4a, 4b, and 4c for color display by the three primary colors R, G, and B.

For example, the color filters 29R and 29B are provided with openings 36a and 36b having the illustrated rectangular shapes and blend in the white color. By adjusting the arrangement, size, and number of the openings 36a and 36b, it is possible to adjust the amounts of the light passing through the openings 36a and 36b and thereby adjust the reflection type display luminance.

Note that, the arrangement, number, and the size of the openings can be set according to need.

In order to prevent light reflection at the signal lines 6a, 6b, 6c, and 6d shown in FIG. 28, in the present embodiment, in the same way as the second embodiment, as shown in FIG. 29, the adjacent color filters 29R and 29G and 29G and 29B are, for example, formed between them with light blocking films 102a and 102b made of metal films such as chromium which block light from the signal lines 6a, 6b, 6c, and 6d.

As will be explained later, in the present embodiment, spacers are provided at the intersecting portion of the signal line 6c and the gate line 5a and at the intersecting portion of the signal line 6c and the gate line 5b. For this reason, the two ends of the boundary line of the color filters 29G and 29B corresponding to the intersecting portion of the signal line 6c and the gate line 5b and the intersecting portion of the signal line 6c and the gate line 5b are formed with a film made of a metal film of for example chromium for blocking light from the spacers.

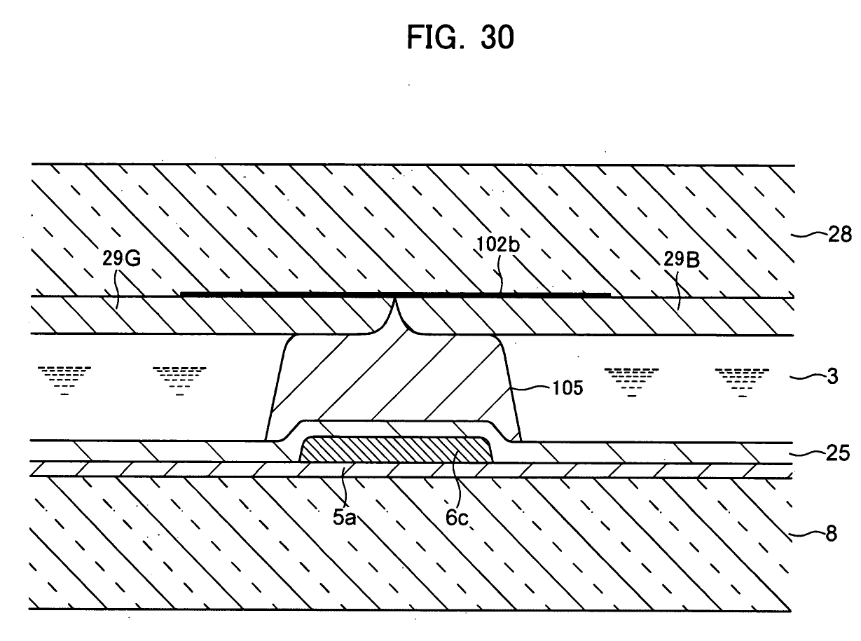

FIG. 30 is a sectional view of principal parts of the display panel 1A shown in FIG. 19 along a line e-e′ in FIG. 28.

In FIG. 30, components similar to those of FIG. 19 use the same notations.

As shown in FIG. 30, spacers 105 are provided at the intersecting portion of the signal line 6c and the gate line 5a and at the intersecting portion of the signal line 6c and the gate line 5b via a transparent insulating film 25 or the like on the signal line 6c and the gate line 5a. The spacers 105 are formed with a metallic light blocking film 102b at the adjacent portions of the color filters 29G and 29B.

According to the present embodiment, the metallic light blocking film 102 is formed between the color filters 29b to block light from the signal lines 6. Further, spacers 105 are formed at the intersecting portions of the gate lines 5 and the signal lines 6, and the spacers 105 are formed above them with the metallic light blocking film. Further, the color filters are formed with the openings 36a and 36b to blend in the white color. Due to this, the nondisplay regions due to the spacers are suppressed as much as possible, reflection on the signal lines is prevented, the increase of the capacitance between the gate lines and the signal lines is suppressed, and the luminance and the image quality of the reflection type display are improved.

Fifth Embodiment

The liquid crystal display of the fifth embodiment is a dual transmission and reflection type liquid crystal display having the same fundamental structure as that of the display panel 1A shown in FIG. 19.

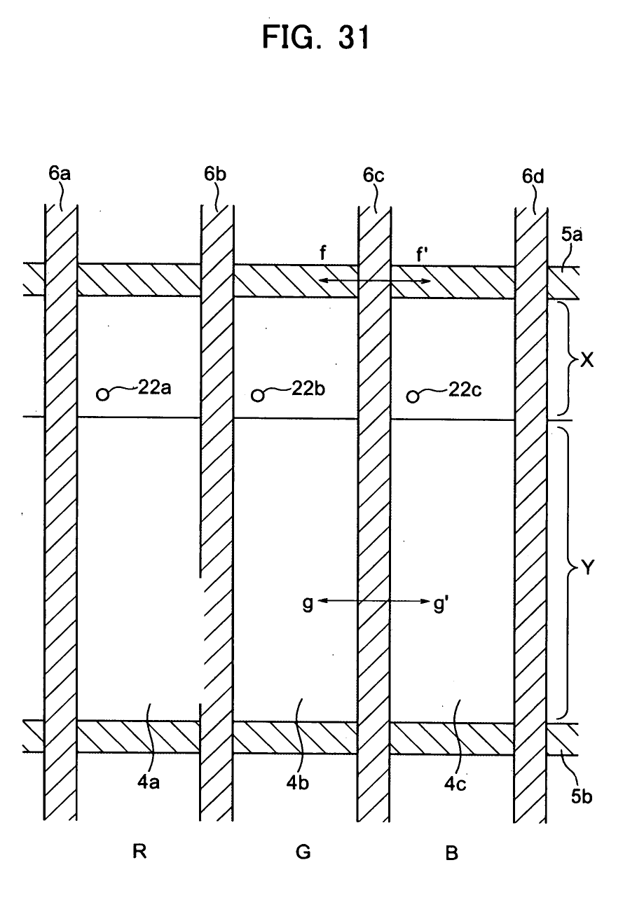

FIG. 31 is a plan view of the arrangement of interconnects in the three pixel regions 4a, 4b, and 4c for displaying the three colors R, G, and B. In FIG. 31, the adjacent portions of the pixel regions 4a, 4b, and 4c are provided with the gate lines 5a and 5b and the signal lines 6a, 6b, 6c, and 6d so as to intersect each other.

In the present embodiment as well, as will be explained later, the spacers are formed at the intersecting portions of the gate lines 5 and the signal line 6c.

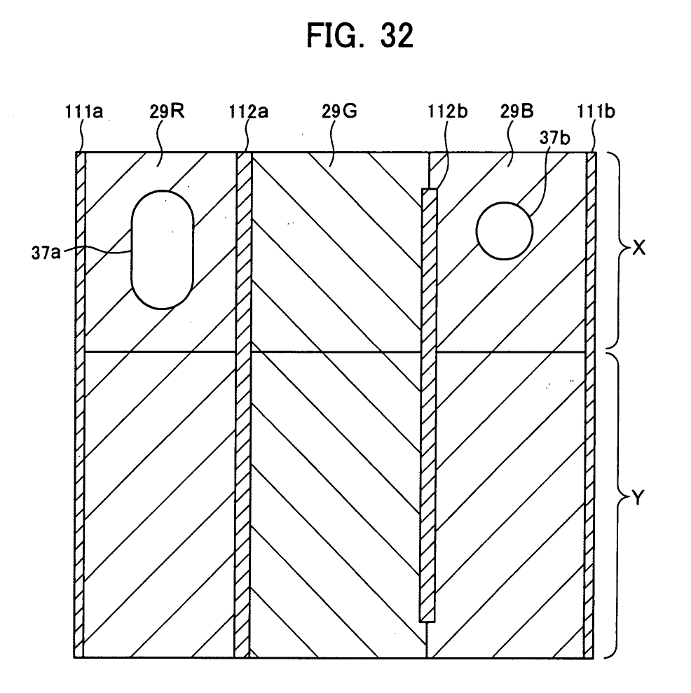

FIG. 32 is a plan view of the arrangement of color filters at the display panel 1. The color filters 29R, 29G, and 29B are colored to the R, G, and B colors, arranged at locations matching with the pixel regions 4a, 4b, and 4c, and color the reflection display light and the transmission display light from the pixel regions 4a, 4b, and 4c for the color display by the three primary colors R, G, and B. For example, the color filters 29R and 29B are provided with openings 37a and 37b having shapes as illustrated, blend the white color, and adjust the reflection type display luminance.

Note that the arrangement, number, and the size of the openings can be set according to need.

In order to prevent the light reflection at the signal lines 6a, 6b, 6c, and 6d shown in FIG. 31, in the present embodiment, in the same way as the first embodiment, as shown in FIG. 32, the red, green, and blue color filters 29R, 29G, and 29B are superimposed on each other, whereby the colors of their superimposed regions 112a and 112b become deeper and thus function as the good shields.

As will be explained later, in the present embodiment, spacers are provided at the intersecting portion of the signal line 6c and the gate line 5a and at the intersecting portion of the signal line 6c and the gate line 5b.

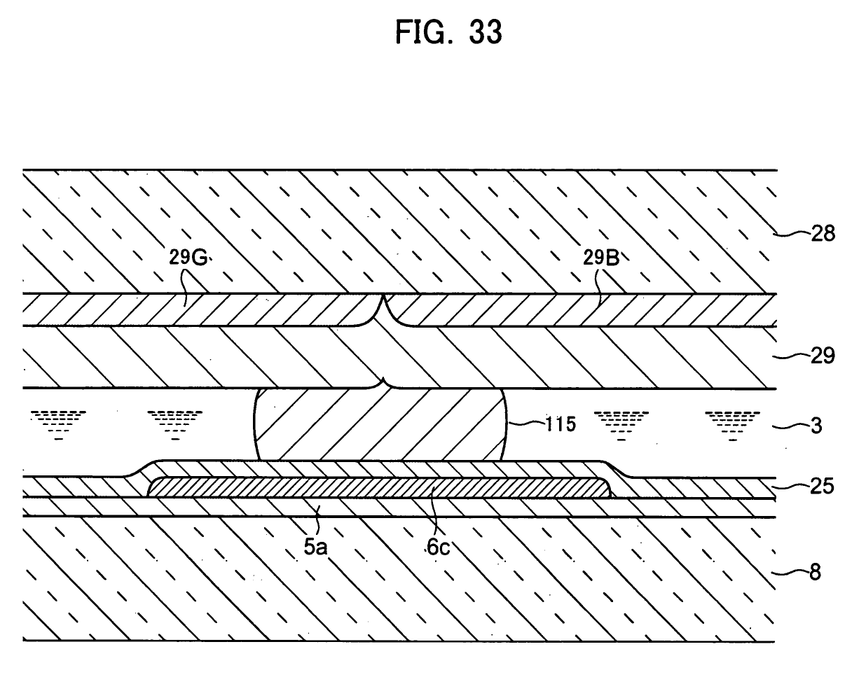

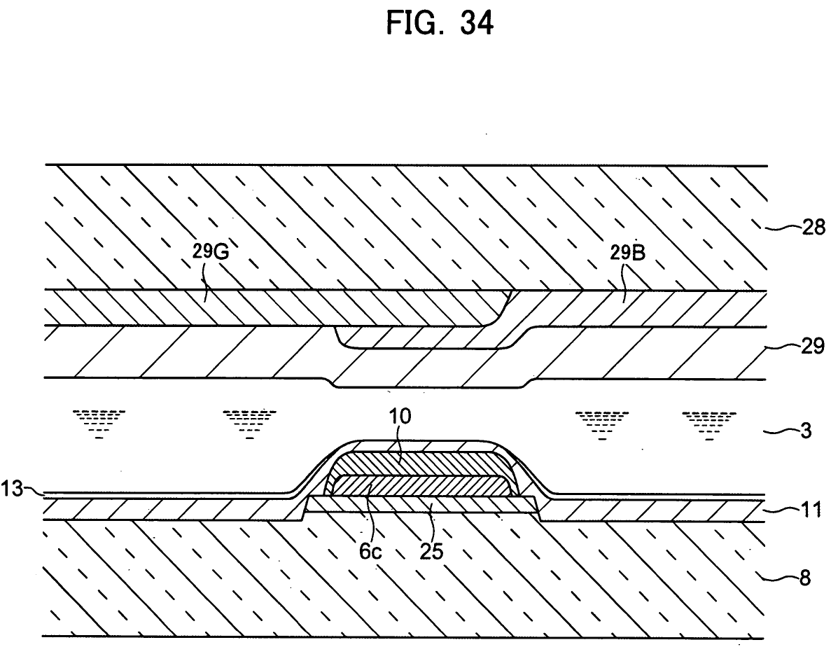

FIG. 33 is a sectional view of principal parts of the display panel 1A shown in FIG. 19 along a line f-f′in FIG. 31. FIG. 34 is a sectional view of the principal parts of the display panel 1A shown in FIG. 19 along a line g-g′ in FIG. 31.

In FIG. 33 and FIG. 34, components similar to those in FIG. 19 use the same notations.

As shown in FIG. 33, spacers 115 are provided at the intersecting portion of the signal line 6c and the gate line 5a and at the intersecting portion of the signal line 6c and the gate line 5b via the transparent insulating film 25 or the like on the signal line 6c and the gate line 5a. The spacers 115 have the color filters 29G and 29B arranged on them.

FIG. 34 shows the structure of a region where no spacer 115 is formed. In FIG. 34, the color filters 29G and 29B are superimposed and block the ambient from striking the signal line 6c via the transparent flattening layer 11.

According to the present embodiment, the adjacent color filters 29b are superimposed to block light from the signal lines 6 as shields. Further, the spacers 115 are formed at the intersecting portions of the gate lines 5 and the signal lines 6. Further, the color filters are formed with openings 37a and 37b to blend in the white color. Due to this, the nondisplay regions due to the spacers are suppressed as much as possible, reflection on the signal lines is prevented, and the luminance of the reflection type display is improved.

Sixth Embodiment

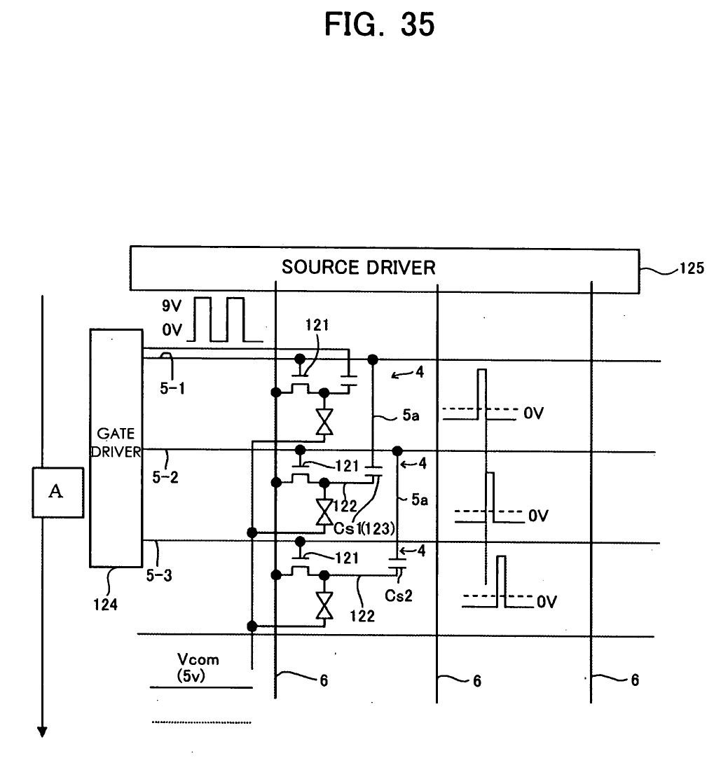

Next, an explanation will be given of a fifth embodiment of the present invention in relation to FIG. 35 to FIG. 40.

In the first to fifth embodiments explained above, an explanation was given of a liquid crystal display wherein the Cs line 7 was independently interconnected and an auxiliary capacitor C was formed between this Cs line 7 and the connection electrode 20, but the present invention is not limited to a liquid crystal display having such a configuration.

Therefore, the sixth embodiment is configured so as to be applied also to a liquid crystal display having a so-called Cs-on-gate structure formed, for example as shown in FIG. 35, without independently laying a Cs line, but imparting the role of the Cs line to the gate line and superimposing an auxiliary capacitor on this gate line.

A liquid crystal display having the Cs-on-gate structure, as shown in FIG. 35, is provided with pixel regions 4 formed into a matrix by laying a plurality of gate lines 5 and a plurality of signal lines 6 orthogonal to each other. A TFT portion 121 where a TFT is formed at an intersecting point of a gate line 5 and a signal line 6 is formed for every pixel region 4. Each gate line 5 is provided with an extension 6a extending along the signal line 6 to the opposite side from the connection side with the TFT portion 121. Further, in the pixel region 4, a connection electrode 122 connected to the TFT via the TFT portion 121 is laid so as to face an extension 5 of the gate line 5 of the previous stage. In the liquid crystal display having such a constitution, a superimposed portion of the extension 5a of the gate line 5 of the previous stage and the connection electrode 122 is used as an auxiliary capacitor region in which the auxiliary capacitor is formed (hereinafter referred to as a “Cs region”) 123.

Further, in FIG. 35, each gate line 5 is driven by a gate driver 124, and each signal line 6 is driven by a source driver 125.

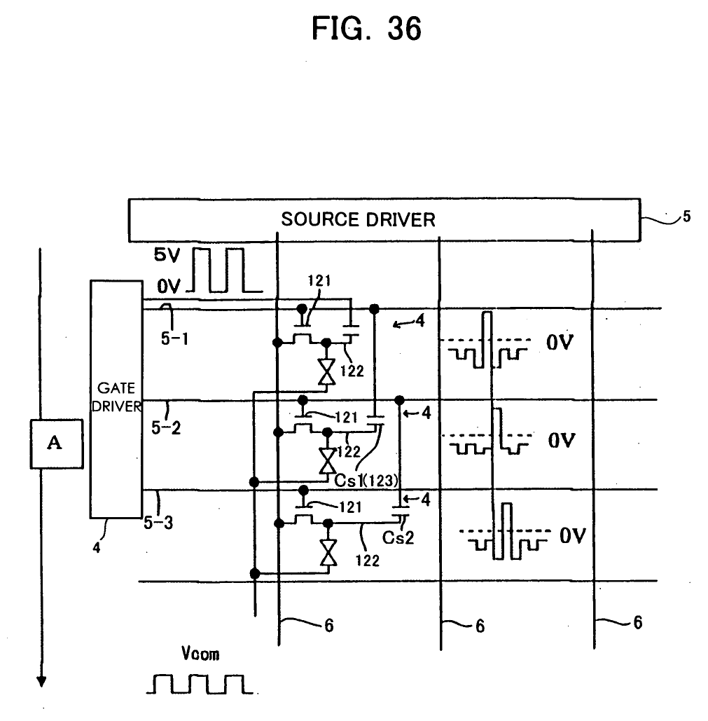

Further, FIG. 36 is an equivalent circuit diagram of a liquid crystal display employing a driving method different from that of FIG. 35.

In the circuit of FIG. 35, a constant counter potential Vcom was supplied, but the circuit of FIG. 36 employs a driving method applying a counter voltage Vcom obtained by inverting the polarity for every 1H. In this case, while a signal potential of 9V was necessary in the circuit of FIG. 35, in the circuit of FIG. 36, a signal potential of 5V is satisfactory.

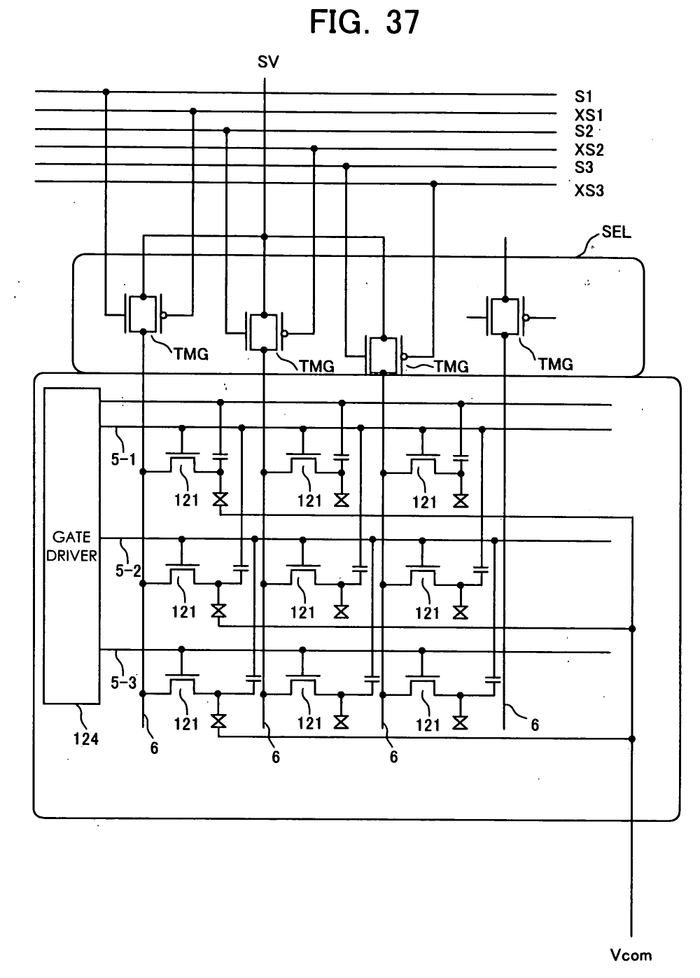

Further, FIG. 37 is an equivalent circuit diagram of a liquid crystal display having a panel circuit of low temperature polycrystalline silicon. Note that, also in FIG. 37, the same notations are attached to similar components to those of FIG. 35 and FIG. 36.

The circuit of FIG. 37, different from the circuits of FIG. 35 and FIG. 36, employs a configuration wherein the source driver is not mounted on the same panel. A signal SV from a not illustrated source driver is transferred to the signal line 6 via a selector SEL having a plurality of transfer gates TMG. The transfer gates (analog switches) TGM are controlled in the conductive state by selection signals S1 and XS1, S2 and XS2, S3 and XS3, . . . taking complementary levels from the outside.

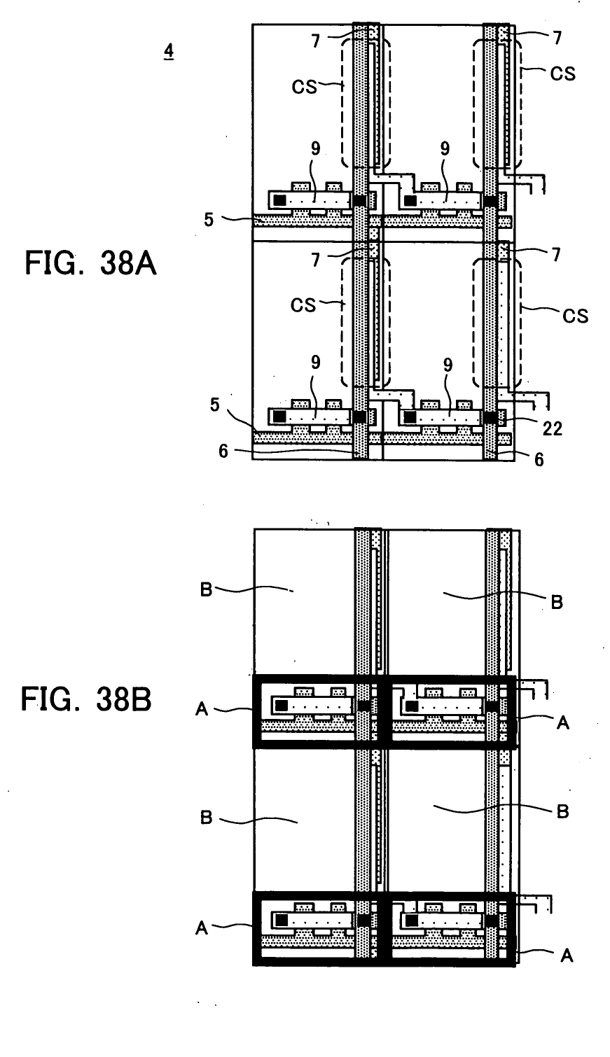

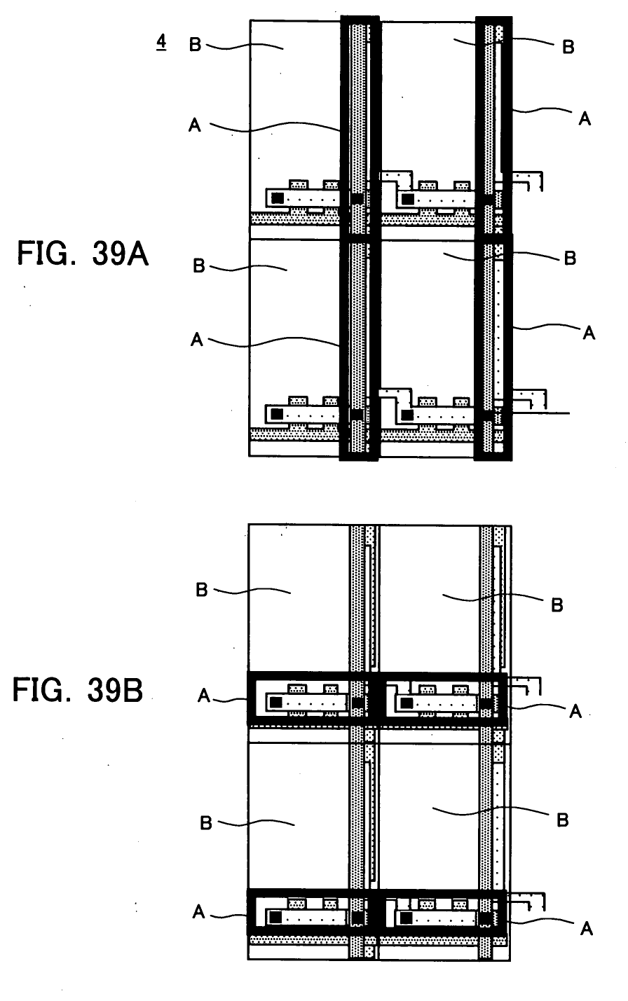

FIGS. 38A and B and FIGS. 39A and B are views of examples where the reflection region A is formed just above the interconnects in a so-called Cs-on-gate structure wherein the CS line 7 and the gate line 5 are shared.

FIG. 38A is a plan view of 2×2 pixel regions. In these pixel regions, a plurality of gate lines 5 and a plurality of signal lines 6 are interconnected orthogonal to each other and form a matrix. A TFT 9 is formed at an intersecting point of the gate line 5 and the signal line 6 for each pixel.

Each gate line 5 is provided with a CS line 7 along the signal line 7 and at the side opposite to the connection side with the TFT 9. The CS line 7 is not independently laid. A storage capacitor CS is formed as illustrated between the gate line 5 and the gate line of the previous stage.

The reflection region A of the reflection electrode 62 is formed in the region just above either of the gate line interconnect region, the signal line interconnect region, the CS forming region, and the TFT forming region made of metal film or a region obtained by combining a plurality of these regions.

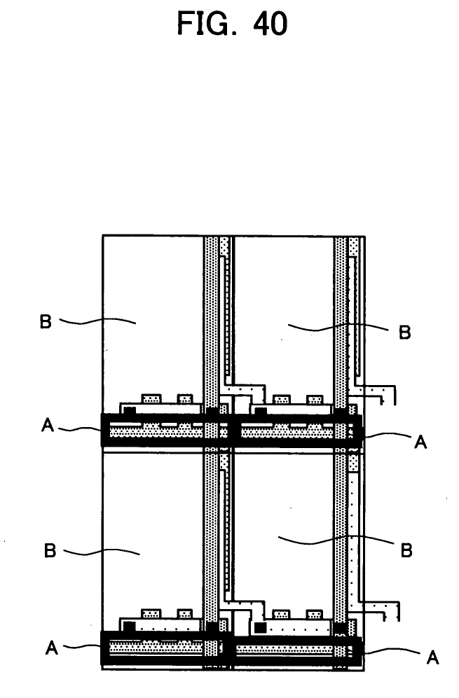

FIG. 38B shows a case where the gate line interconnect region and the TFT forming region are used as the reflection region A; FIG. 39A shows a case where only the signal line interconnect region is used as the reflection region A; FIG. 39B shows a case where only the TFT forming region is used as the reflection region A; and FIG. 40 shows a case where only the gate line is used as the reflection region A.

By effectively using the space in the pixel in this way, a large area of the transmission region B can be secured, and the transmittance can be improved.

In such a liquid crystal display as well, in the pixel region 4, the reflection region A is provided just above one of a region wherein a metal film such as a metal interconnect for blocking light from the backlight of the internal light source is provided, specifically a region wherein the above gate line 5 is laid or a region wherein the signal line 6 is laid, a region wherein the Cs region 123 is formed, the TFT portion 121 wherein a TFT is formed, or a region obtained by combining a plurality of these regions.

For example, in a pixel region 4 having a configuration as shown in FIG. 38A, the reflection region A is provided just above the Cs line interconnect region and the gate line interconnect region shown in FIG. 38B. In this way, by effectively utilizing the region for blocking light from the internal light source to form the reflection region A, the pixel region 4 can be divided to the reflection region A and the transmission region B. As a result, a structure stressing the transmission type can be formed by securing a large area of the transmission region B.

Further, in the above pixel region 4, by forming the opening 33 at a portion corresponding to the reflection region of the color filters (illustration is omitted) provided corresponding to this pixel region 4 and forming a smooth reflection electrode on the flattening layer, the reflectance and the transmittance in the display panel can be set in the above range, that is, the reflectance can be set to 10 percent or more, and the transmittance can be set in a range of 4 percent to 10 percent.

An explanation will be given of the method of driving the liquid crystal display of FIG. 35 having the above Cs-on-gate structure. In the case of such a Cs-on-gate structure, in order to add the Cs capacitance function to the gate line of the previous stage, when the gate line of a certain stage is in the ON state, it is necessary to bring the gate line of the previous stage to the OFF state in order to suppress capacitance fluctuation. In this liquid crystal display, a constant counter potential Vcom of for example 5V is applied, and the gate waveform becomes a waveform as shown in the same diagram.

In the liquid crystal display, the first gate line 5-1 is first set ON, then the gate potential is fixed at the OFF potential. Next, the second gate line 5-2 is set ON. At this time, a first gate line 5-1 having the Cs line function has been set OFF, and therefore the held charge of the pixel is injected into the auxiliary capacitor Cs1 (Cs region 93) connected to the first gate line 5-1 through the source and the drain of the TFT portion 91, and the pixel potential is decided. Then, the second gate line 5-2 is set OFF and, at the same time, the third gate line 5-3 is set ON, and similar to the storage capacitor Cs1 explained above, the held charge is injected into the storage capacitor Cs2 connected to the second gate line 5-2 and the pixel potential is decided.

Note that, in the above driving method, the scan direction is an arrow A direction in FIG. 35. Further, the OFF potential in this driving method is −3V, but the OFF potential was set at this voltage because a potential for completely cutting the current was a minus potential in Nch used in the TFT portion 121, and where the current cut potential of the TFT portion 121 is on the plus side, a GND potential can be naturally brought to the OFF potential.

The present invention was explained above based on the preferred embodiments, but the present invention is not limited to the embodiments explained above. Various modifications are possible within a range not out of the gist of the present invention.

As explained in detail above, in the liquid crystal display according to the present invention, by adjusting the size of the openings through which the light having little attenuation passes, the reflectance in the reflection type display can be adjusted, therefore the reflectance in the reflection type display is improved without narrowing the transmission region and thereby reflection type display with a high luminance and a high color reproducibility becomes possible. Accordingly, according to the present invention, it becomes possible to employ a structure stressing the transmission type having a wide area for the display region and able to maintain the luminance in the transmission type display at a high level while realizing reflection type display with a high luminance and a good color reproducibility by a high reflectance. This structure stressing the transmission type enables the color reproducibility and the viewability in the transmission type display to be improved.

Further, since the adjacent color filters are superimposed to block light from the signal lines as shields, the light blocking film can be easily produced while suppressing the reflection on the signal lines without increasing the production steps. Further, the light blocking film is formed between the adjacent color filters or at locations corresponding to the spacers to block light from the signal lines, so reflection on the signal lines is suppressed. Further, since the spacers are formed on the signal lines, nondisplay regions not able to display can be suppressed as much as possible. Further, the color filters are formed with openings to blend in white color, so the luminance of the reflection type display is improved.

Further, according to the present invention, by setting the transmittance of the display panel of the liquid crystal display at 4 percent to 10 percent and setting the reflectance in the range from 1 percent to 30 percent, it becomes possible to deal with a high definition display while securing a display light luminance equivalent to that of a display device performing only transmission type display and a reflection display light luminance required for display without increasing the power consumption of the liquid crystal display.

Further, by providing color filters covering only the transmission region, it becomes possible to further improve the reflectance.

Further, by providing an opening in the color filters corresponding to the reflection region, a reflection region of a high reflectance can be obtained, the area of the reflection region for obtaining the viewability of at least the required level can be reduced, and as a result a liquid crystal display stressing a transmission type able to secure a large transmission region can be realized.

Further, since low temperature polycrystalline silicon is used, the size of the thin film transistor TFT for every pixel can be reduced and the entire area of the reflection region and the transmission region increases. Further, by forming the reflection film made of a metal having a high reflectance or a smooth reflection film, particularly by forming this just above an interconnect region, the area of the transmission region can be increased and both of the reflectance and the transmittance can be improved.

Accordingly, according to the present invention, in a dual reflection and transmission type liquid crystal display, the viewabilities and the color reproducibilities of both of the reflection display and the transmission type display can be improved.

Industrial Applicability

As described above, the liquid crystal display according to the present invention can improve the viewability and the color reproducibility of both of the reflection display and the transmission type display, so can be applied to electronic apparatuses such as laptop type personal computers, displays for car navigation, personal digital assistants (PDA), mobile phones, digital cameras, and video cameras.

1. An liquid crystal display having a display panel comprised of a substrate formed with a pixel region having a reflection region for reflection type display and a transmission region for transmission type display and a substrate formed with a color filter located corresponding to the pixel region arranged facing each other across a liquid crystal layer, wherein
the color filter located corresponding to the reflection region is formed under the same condition as that for the color filter located corresponding to the transmission region, and is formed with one or more uncolored regions.

2. A liquid crystal display as set forth in claim 1, wherein a reflectance of light at said display panel due to said reflection region is at least 1 percent and not more than 30 percent and a transmittance of light at said display panel due to said transmission region is at least 4 percent and not more than 10 percent.

3. A liquid crystal display as set forth in claim 1, wherein said uncolored region includes an opening.

4. A liquid crystal display as set forth in claim 1, wherein said uncolored region is formed at a location corresponding to substantially the center of said reflection region.

5. A liquid crystal display as set forth in claim 1, wherein said uncolored region is formed to at least a 1 μm of an opening width and not more than the area of said reflection region.

6. A liquid crystal display as set forth in claim 1, wherein said uncolored region is polygonal in shape.

7. A liquid crystal display as set forth in claim 1, wherein said uncolored region is circular in shape.

8. A liquid crystal display including a plurality of pixel regions arranged in a matrix between a first substrate and a second substrate, a plurality of gate lines connecting the plurality of pixel regions and selecting a pixel region for display, and a plurality of data signal lines connecting the plurality of pixel regions and transmitting image data to said pixel region to perform the display, wherein:
each pixel region has a reflection region for display by reflecting light from the outside and a transmission region for display by passing light from an internal light source arranged in parallel;
in each pixel region, color filters are provided on said first substrate at locations corresponding to said reflection region and said transmission region;
color filters of adjacent pixel regions are superimposed at a boundary region; and
an uncolored region is formed at part of the corresponding region of said reflection region.

9. A liquid crystal display as set forth in claim 8, wherein a data signal line has formed on it between said first and second substrates a spacer for controlling a gap between said first and second substrates.

10. A liquid crystal display as set forth in claim 9, wherein said uncolored region is formed at a location of said color filters corresponding to a portion other than the regions where said spacers of said reflection region are formed and said superimposed regions.

11. A liquid crystal display as set forth in claim 10, wherein said uncolored region is formed at a location of said color filters corresponding to substantially the center of said reflection region.

12. A liquid crystal display as set forth in claim 11, wherein said uncolored region includes an opening.

13. A liquid crystal display as set forth in claim 8, wherein a region where a data signal line and a gate line intersect has formed at it between said first and second substrates a spacer for controlling a gap between said first and second substrates.

14. A liquid crystal display as set forth in claim 13, wherein said uncolored region is formed at a location of said color filters corresponding to a portion other than a region where said spacer of said reflection region is formed.

15. A liquid crystal display as set forth in claim 14, wherein said uncolored region includes an opening.

16. A liquid crystal display including a plurality of pixel regions arranged in a matrix between a first substrate and a second substrate, a plurality of gate lines connecting the plurality of pixel regions and selecting a pixel region for display, and a plurality of data signal lines connecting the plurality of pixel regions and transmitting image data to said pixel region for display, wherein
each pixel region has a reflection region for display by reflecting light from the outside and a transmission region for display by passing the light from an internal light source arranged in parallel;
each pixel region is provided with color filters at locations on said first substrate corresponding to said reflection region and said transmission region;
said first substrate is provided between said color filters of adjacent pixel regions with a light blocking film for blocking the light from the outside; and
an uncolored region is formed at part of the corresponding regions of said reflection region.

17. A liquid crystal display as set forth in claim 16, wherein a data signal line has formed on it between said first and second substrates a spacer for controlling a gap between said first and second substrates.

18. A liquid crystal display as set forth in claim 17, wherein said uncolored region is formed at a location of said color filters corresponding to a portion other than a region where said spacer of said reflection region is formed.

19. A liquid crystal display as set forth in claim 18, wherein said uncolored region includes an opening.

20. A liquid crystal display as set forth in claim 16, wherein a region where a data signal line and a gate line intersect has formed at it between said first and second substrates a spacer for controlling a gap between said first and second substrates.

21. A liquid crystal display as set forth in claim 20, wherein said color filters are provided with a light blocking film at a location corresponding to a region of said reflection region where said spacer is formed.

22. A liquid crystal display as set forth in claim 21, wherein said uncolored region is formed at a location of said color filters corresponding to a portion other than a region where said spacer of said reflection region is formed.

23. A liquid crystal display as set forth in claim 22, wherein said uncolored region includes an opening.
